(19) United States
(12) Patent Application Publication
(10) Pub. No.: US 2022/0410076 A1
(43) Pub. Date: Dec. 29, 2022

(54) METHODS FOR COUPLING A LIGAND TO A COMPOSITE MATERIAL

(71) Applicant: MERCK MILLIPORE LTD., Carrigtwohill (IE)

(72) Inventors: Matthew T. Stone, Arlington, MA (US); Santosh Rahane, Harvard, MA (US); Joaquin A. Umana, Reading, MA (US); Gary Skarja, Burlington (CA); Elena N. Komkova, Burlington (CA); Melissa Vandersluis, Hamilton (CA); Amro Ragheb, Burlington (CA)

(21) Appl. No.: 17/779,054

(22) PCT Filed: Nov. 20, 2020
(86) PCT No.: PCT/EP2020/082787

§ 371 Date: May 23, 2022

Related U.S. Application Data
(60) Provisional application No. 62/938,761, filed on Nov. 21, 2019.

(51) Int. Cl. B01D 67/00; B01D 69/10; B01D 71/40; B01D 69/14

(52) U.S. Cl. CPC B01D 67/0093; B01D 69/106; B01D 71/40; B01D 69/144

(57) ABSTRACT

Disclosed are methods for coupling a ligand to a composite material. Covalent bonds are formed between functionalized composite materials and ligands as a ligand solution flows through or across the composite materials. The composite materials are useful as chromatographic separation media.

### BACKGROUND

Membrane-based water treatment processes were first introduced in the 1970s. Since then, membrane-based separation technologies have been utilized in a number of other industries. In the pharmaceutical and biotechnology industries, the use of preparative chromatography, direct flow filtration (DFF) and tangential flow filtration (TFF), including micro-, ultra-, nano-filtration and diafiltration are well-established methods for the separation of dissolved molecules or suspended particulates. Ultrafiltration (UF) and microfiltration (MF) membranes have become essential to separation and purification in the manufacture of biomolecules. Biomolecular manufacturing, regardless of its scale, generally employs one or more steps using filtration. The attractiveness of these membrane separations rests on several features including, for example, high separation power, and simplicity, requiring only the application of pressure differentials between the feed stream and the permeate. This simple and reliable one-stage filtering of the sample into two fractions makes membrane separation a valuable approach to separation and purification.

Ligands conjugated to the fluid-accessible surfaces of the composite material, such as a membrane, are useful in separation and purification methods. However, the chemical modification of a membrane is more challenging than a resin. A resin can be easily suspended in solution, and therefore a resin can be modified in large reactors where diffusion of the reagents into the resins is facilitated by stirring the suspension. Membranes are more challenging to modify as they must be supported during the modification process to avoid damaging the membrane structure. This can be accomplished in roll-to-roll processes where the membrane is physically moved through a trough of the reaction solution when the kinetics of the reaction are very fast. Modification of a membrane with a slower reaction chemistry, such as the coupling of a Protein A ligand with an activated membrane, requires a longer reaction time. Longer reactions times preclude roll-to-roll membrane modification processes which would require extremely slow movement of the membrane and thus extremely long processing times.

There exists a need for composite material modification processes where the reaction solutions flow through a supported assembly of composite material over a long period of time. Increasing the ligand coupling to the composite materials improves the binding capacity of affinity media. Conjugation methods should leverage fast, efficient, and easily-controllable reactions to couple ligands to composite materials.

### SUMMARY

In one aspect, the invention relates to methods for coupling a ligand to a functionalized composite material, wherein the functionalized composite material is arranged in a coplanar stack of coextensive sheets, a tubular configuration, or a spiral wound configuration, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member; and
b. flowing at a first flow rate a first solution substantially through or substantially across the functionalized composite material, wherein the first solution comprises a plurality of first ligands, such that a plurality of covalent bonds forms between the reactive functional groups and the first ligands.

### BRIEF DESCRIPTION OF THE FIGURES

FIG. 1A depicts a schematic representation of an exemplary composite material stacked between layers of interleaf (e.g., a screen) with fluid flow substantially across the layers of functionalized composite material (tangential flow).

FIG. 1B depicts a schematic representation of an exemplary composite material stacked between layers of interleaf (e.g., a screen) with fluid flow substantially through the layers of functionalized composite material (direct flow).

FIG. 2 shows an exemplary composite material with a layer of interleaf in a spiral wound configuration.

FIG. 3 shows the IgG dynamic binding capacity at a flowrate of 10 membrane volumes/minute of the Protein A affinity ligand membranes conjugated using the flow through method compared to membrane conjugated using a batch method.

FIG. 4 is a cartoon illustrating the composite material layers (i.e., membrane), layers of interleaf (i.e., screen), and flow distributing layers assembled in a chromatography column. This pattern containing 10 membranes was repeated 9 additional times until 100 membranes were assembled. Then one additional flow distributing layer was added.

FIG. 5A shows the IgG dynamic binding capacity as a function of the membrane position within the stack.

FIG. 5B shows the membrane flux as a function of the membrane position within the stack.

FIG. 6 is a cartoon illustrating the different locations where circular sections of composite material were removed from the rectangular membrane sheet after tangential flow coupling with a Protein A ligand on a spiral wound roll interleaved with a screen.

### DETAILED DESCRIPTION

### Overview

The capacity of affinity media depends largely on the amount of affinity ligand that can be conjugated to the fluid-accessible surfaces of the media, such as a composite material. Conjugation methods that increase ligand coupling to a composite material will increase binding capacity. In some embodiments, these methods leverage fast, efficient, and easily-controllable reactions to functionalize composite materials. In some embodiments, the composite material is an adsorptive macroporous chromatography membrane. In some embodiments, a method for affinity ligand conjugation that involves direct flow of the ligand solution through the membrane (i.e., dead-end flow) or across the membrane (i.e., tangential flow), produces an affinity membrane with improved dynamic binding capacity in comparison to batch or static conjugation methods.

Chromatographic membranes exploit a fast, convective mass transport mechanism to facilitate rapid purification or separation operations. To maximize the productivity of these operations, however, the binding capacity of the membrane for the target compound must be maximized. In some embodiments, this invention describes a flowthrough or dead-end flow process for conjugating a ligand to a membrane containing pendant reactive functional groups under appropriate conditions of flowrate, buffer pH and concentration, affinity ligand concentration, and exposure time. In some embodiments, this invention describes a crossflow or tangential flow process for conjugating a ligand to a membrane containing pendant reactive functional groups under appropriate conditions of flowrate, buffer pH and concentration, affinity ligand concentration, and exposure time. In some embodiments, the methods produce conjugated affinity chromatography membranes with protein binding capacities greater than achieved by using batch, non-flow conjugation methods using similar buffer conditions and affinity ligands.

The flowthrough and crossflow conjugation methods produces consistently higher membrane binding capacity and may be carried out on equipment that contains in-line measurement tools that permits real time observation of reaction progression and thereby reaction process optimization. The higher membrane binding capacity, combined with fast binding kinetics enables rapid, highly productive chromatographic purification operations.

### Definitions

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

In describing the present invention, a variety of terms are used in the description. Standard terminology is widely used in filtration, fluid delivery, and general fluid processing art.

The articles “a” and “an” are used herein to refer to one or to more than one (i.e., to at least one) of the grammatical object of the article. By way of example, “an element” means one element or more than one element.

The terms “comprise” and “comprising” are used in the inclusive, open sense, meaning that additional elements may be included.

The term “including” is used to mean “including but not limited to.” “Including” and “including but not limited to” are used interchangeably.

The term “affinity chromatography” refers to a separation method based on a specific binding interaction between an immobilized ligand and its binding partner. Examples of the specific binding interactions include, but are not limited to, antibody/antigen, enzyme/substrate, and enzyme/inhibitor interactions.

The term “affinity media” refers to material comprising a plurality of immobilized ligands. For example, a composite material comprising covalently bound ligands.

The term “polymer” refers to a large molecule formed by the union of repeating units (monomers). The term polymer also encompasses copolymers.

The term “co-polymer” refers to a polymer of at least two or more different monomers. A co-polymer can be comprised of a cross-linker and a monomer, if the cross-linker is a difunctional monomer.

The term “functionalized composite material” refers to a macroporous cross-linked gel comprising a plurality of pendant reactive functional groups located in the pores of a support member.

The term “pendant reactive functional group” refers to a functional group that will form one or more covalent bonds with a ligand when the ligand solution is contacted with the functional group. Examples of pendant reactive functional groups that will form a covalent bond with ligands comprising an amine group include, but are not limited to, epoxides, aldehydes, carboxylic acids, reactive halogens, reactive esters, isocyanates, isothiocyanates, sulfonyl halides, carboniimides, acyl azides, fluorobenzenes, carbonates, N-hydroxysuccinimides ester, imidoesters, and fluorophenyl esters. Examples of pendant reactive functional groups that will form a covalent bond with ligands comprising a thiol group include, but are not limited to, epoxides, thiols, disulfides, carbon-carbon double bonds, carbon-carbon triple bonds, maleimides, haloacetyls, pyridyl disulfide, thiosulfates, and reactive halogens.

The term “ligand” refers to a molecule that binds a specific binding partner. For example, a protein, an antibody, a hormone, or a drug bind to particular receptors.

As used herein, the term “Protein A” or “PrA” refers to a bacterial protein from Staphylococcus aureus, a Protein A derivative, or a recombinant Protein A with the capacity to bind mammalian antibodies of class immunoglobulin G (IgG) with high affinity. For example, Protein A can be recovered from a native source thereof (e.g., Staphylococcus aureus). Protein A can be produced synthetically (e.g., by peptide synthesis or by recombinant techniques), and fragments and variants thereof which retain the ability to bind proteins which have a CH2/CH3 region, such as an Fc region. Protein A can be purchased commercially, for example, from Repligen, Pharmacia, EMD Millipore and Fermatech. The gene for Protein A has been cloned and expressed in Escherichia coli allowing for the production of large quantities of recombinant Protein A and Protein A derivatives.

The term “wash solution” in connection with coupling methods refers to a solution that will carry away coupling reactants. That is, a solution that will remove any excess polymerizable monomer and any excess ligands.

The term “quenching solution” in reference to the coupling methods is used to mean a solution comprising a reactive compound that will covalently bond with any residual pendant reactive functional groups to form a non-reactive group. That is, the reactive compound will convert any residual pendant reactive functional groups to non-reactive groups.

The term “non-reactive groups” refers to groups that will not form covalent bonds under the conditions of further coupling reactions and separation methods. For example, exposure of the non-reactive groups to a fluid comprising a mixture of substances will not result in the formation of a covalent bond between the substance and the non-reactive group.

The term “buffer” refers to a solution that resists changes in pH by the action of its acid-base conjugate components. Various buffers which can be employed in the methods described herein are described in Buffers. A Guide for the Preparation and Use of Buffers in Biological Systems, Gueffroy, D., ed. Calbiochem Corporation (1975). Different buffers maintain different ranges of pH, for example phosphate buffer is usually used for pH between 6.0 and 8.0, while for a higher pH, a borate buffer can be used, and for lower pH, a carbonate buffer can be used. Persons of ordinary skill in the art will be able to readily identify a suitable buffer to use, depending on the pH to be maintained. Non-limiting examples of buffers that can be used in the methods according to the present invention include MES, MOPS, MOPSO, Tris, HEPES, phosphate, acetate, citrate, succinate, carbonate, borate, and ammonium buffers, as well as combinations of these.

The term “crossflow” in reference to fluid flow and filtration is used to mean a fluid flow or a filtration configuration in which a flowing fluid is directed along the surface of a composite material (e.g., a filter medium), and the portion of fluid that passes through such composite material has a velocity component which is “cross-wise”, i.e., perpendicular to the direction of the fluid flowing along the surface of such composite material.

The term “tangential flow” or “tangential filtration” is used to mean a fluid flow or a filtration process in which a flowing fluid is directed substantially parallel (i.e., tangential) to the surface of a composite material (e.g., a filter medium), and a portion of fluid passes through such composite material to provide a permeate. The terms “tangential filtration” and “crossflow filtration” are often used interchangeably in the art.

The term “dead-end” in reference to fluid flow and filtration is used to mean a fluid flow or a filtration configuration in which a flowing fluid is directed through a composite material (e.g., a filter medium), and the portion of fluid that passes through such composite material has a velocity component which is through, i.e., parallel to the direction of the fluid flowing through such composite material.

The term “direct flow” or “direct filtration” is used to mean a fluid flow or a filtration process in which a flowing fluid is directed substantially through (i.e., direct) to the surface of a composite material (e.g., a filter medium), and a majority of fluid passes through such composite material to provide a filtrate. The terms “direct filtration” and “dead-end filtration” are often used interchangeably in the art.

The term “permeate” is used to mean the portion of the fluid that passes through the filter medium and out through a first outlet port in the filter device that is operatively connected to such filter medium. The term “decantate” is used to mean the portion of the fluid that flows along the surface of the filter medium, but does not pass through such filter medium, and passes out through a second outlet port in the filter device that is operatively connected to such filter medium.

Crossflow filtration and tangential filtration are well known filtration processes. Reference may be had to, e.g., U.S. Pat. Nos. 5,681,464, 6,461,513; 6,331,253, 6,475,071, 5,783,085, 4,790,942, the disclosures of which are incorporated herein by reference. Reference may also be had to “Filter and Filtration Handbook”, 4th Ed., T. Christopher Dickenson, Elsevier Advanced Technology, 1997, the disclosure of which is incorporated herein by reference.

“Bind-elute mode” as used herein, refers to an operational approach to chromatography in which the buffer conditions are established so that both a target protein and undesired contaminants bind to the chromatographic support or composite material. Fractionation of target protein from the other components is achieved subsequently by changing the conditions such that the target protein and contaminants are eluted separately. In certain embodiments, the membranes described herein may be used in “bind-elute mode” featuring high dynamic binding capacities at high conductivity, high volume throughput and selectivity. In certain embodiments, the amount of the target protein in the eluent is reduced by about 50% to about 99%. In certain embodiments, the eluent is reduced in aggregates of the target protein by about 90%, about 91%, about 92%, about 93%, about 94%, about 95%, about 96%, about 97%, about 98%, or about 99%.

As used herein, the term “flow-through mode” refers to an operational approach to chromatography in which the buffer conditions are established so that the intact target protein flows through the membrane upon application while contaminants are selectively retained. In certain embodiments, the membranes described herein may be used in “flow-through mode” in a post-protein A purification process to remove key contaminants, such as DNA, host cell proteins (HCP), leached protein A, undesirable aggregates, and viruses in a single step.

The term “average pore diameter” of the macroporous cross-linked gel may be understood by one of ordinary skill in the art as being determined by any suitable method. For example, average pore diameter may be estimated by environmental scanning electron microscopy (ESEM) images of the surface. ESEM can be a very simple and useful technique for characterising microfiltration membranes. A clear and concise picture of the membrane can be obtained in terms of the top layer, cross-section and bottom layer; the porosity and pore size distribution can be estimated from the photographs.

The “volume porosity” of the support member is determined by a simple calculation. For example, for a support member made with polypropylene, the external dimensions of the support member are measured, and the aggregate volume is calculated [for example, for a flat, circular disk: V=πr² h, the volume of the support member if it were solid, or not porous]. The mass of the support member is then determined. Because the density of polypropylene is known or can be determined from the Polymer Handbook, edited by Brandrup et al., Chapter VII, Wiley and Sons, New York, 1999, the volume porosity is calculated as in the following example:

volume porosity={(volume of support member if solid)−[(mass of support member)/(density of polypropylene)]}/(volume of support member if solid).

In this calculation, the void volume of the support member is =(volume of external dimensions of support member)−[(mass of support member)/(density of polypropylene)]. For example, the density of polypropylene=0.91 g/cm³.

The volume porosity of the composite material, F, is an experimentally-determined value for each composite material. It is calculated by mass. The macroporous cross-linked gel is incorporated into the void volume of the support member. The mass of the incorporated gel is measured after drying to a constant weight. The partial specific volume of the polymer is known or can be determined from the Polymer Handbook, edited by Brandrup et al., Chapter VII, Wiley and Sons, New York, 1999. The maximum volume that the gel could occupy is the void volume of the support member (calculated as described above). The volume porosity of the gel is calculated

ε={(void volume of support member)−[(mass of gel)×(partial specific volume of gel polymer)]}/(void volume of support member)

In some embodiments, the ligand is Protein A (PrA). PrA capture chromatography is one important step in the downstream purification of bio-therapeutic monoclonal antibodies (mAbs). The PrA ligand selectively binds to the Fc and/or Fab binding domain on the mAb while allowing most impurities (host cell proteins, DNA, residual cell culture media) to flow-through the resin. The PrA media is typically washed after the loading step to remove additional impurities and then the captured mAb is eluted at a low pH. The mAb in the elution is significantly more pure and has also been concentrated relative to the clarified cell culture. However, affinity media, e.g., with PrA, is very expensive and must be used for many batches over several years to reduce the cost per batch. Ideally the affinity media could be used for its maximum number of capture chromatography cycles (˜200) for the purification of a single batch of target substance, e.g., mAb, which would significantly reduce volume of PrA media required to process a single batch. Then the PrA media could be disposed of after purifying a single batch of mAb eliminating the costs associated with storing the resin. Currently, most PrA media used in the downstream purification of bio-therapeutic mAbs are in the form of a resin. Slow mass transfer of the mAb into the porous resin structure requires long loading time with residence times ranging from 2 to 10 mins. Lowering the residence time during the loading step significantly decreases the PrA resin's dynamic binding capacity which is defined as the mass of mAb loaded onto the chromatography media divided by the volume of the chromatography media. Longer load times preclude cycling the resin more than a few times (2-4) per batch without extending the PrA capture chromatography step to several days.

A PrA membrane can be loaded at much lower residence times (e.g., 0.1-1 min) and thus offers the opportunity to rapidly cycle the capture chromatography step. In some embodiments, rapid cycling of a PrA membrane allows much more mAb to be purified in the same amount of time relative to a PrA resin of the same volume. Thus, over a given period of time the rapid cycling of a small volume of PrA membrane can be used to capture the same amount of mAb as a much larger volume of resin that is cycled fewer times. In some embodiments, PrA membranes offer the potential to use the full lifetime of a PrA membrane to process a single batch of mAb, significantly reducing the upfront costs for establishing a mAb downstream purification process and eliminating the costs associated with storing the resin.

In some embodiments, Protein A is an affinity ligand. In some embodiments, Protein A is a protein, peptide, or recombinant protein comprising a ligand that binds monoclonal antibodies (e.g., IgG antibodies) and a moiety that can form a covalent bond with a pendant reactive functional group (e.g., thiol of Cys or amine of Lys). In some embodiments, Protein A is a protein, peptide, or recombinant protein comprising a ligand that binds with the Fc domain of an antibody and a moiety that can form a covalent bond with a pendant reactive functional group. In some embodiments, Protein A is a protein, peptide, or recombinant protein comprising a ligand that binds with the Fab domain of an antibody and a moiety that can form a covalent bond with a pendant reactive functional group. In some embodiments, Protein A can form a plurality of covalent bonds with a plurality of pendant reactive functional groups. In some embodiments, Protein A forms multiple covalent bonds to the functionalized composite material.

In some embodiments, Protein A comprises multiple domains. In some embodiments, Protein A comprises 1, 2, 3, 4, 5, 6, 7, or more domains. In some embodiments, the Protein A domains are identical to each other. In some embodiments, the Protein A domains are different from each other. In some embodiments, Protein A is resistant to degradation.

In some embodiments, Protein A is immobilized on a solid phase support material. In some embodiments, Protein A is covalently bonded to the composite material. In some embodiments, Protein A refers to an affinity chromatography resin or column containing chromatographic solid support matrix to which Protein A is covalently attached.

Chemical modification of a composite material is more challenging than a resin. For example, a roll-to-roll modification process of membranes with a slow reaction chemistry would require extremely slow movement of the membrane through a reaction solution and extremely long processing times that are incompatible with modification on a large scale.

In some embodiments, the ligand coupling methods disclosed herein can be used to modify composite materials, such as membranes.

In one aspect, the invention relates to methods for coupling a ligand to a functionalized composite material, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member; and
b. flowing at a first flow rate a first solution substantially through or substantially across the functionalized composite material, wherein the first solution comprises a plurality of first ligands, such that a plurality of covalent bonds forms between the reactive functional groups and the first ligands;

wherein the functionalized composite material is arranged in a coplanar stack of coextensive sheets, a tubular configuration, or a spiral wound configuration.

### Exemplary Functionalized Composite Materials

Composition of the Gels

In some embodiments, the cross-linked gels may be formed through the in situ reaction of one or more polymerizable monomers with one or more cross-linkers. In certain embodiments, the gels may be formed through the reaction of one or more cross-linkable polymers with one or more cross-linkers.

In some embodiments, the cross-linked polymer is macroporous. Porosity within the polymers may be promoted during polymerization by degree of cross-linking, solvent exclusion of the polymeric chain during the formation of the polymer network, or some combination of both. In some embodiments, increased concentrations of cross-linker produce macroporous cross-linked gels. In some embodiments, the porosity is affected by changing the extent of the polymer−(diluent+monomer) interactions, the amount of the cross-linker, the amount of the diluent, the initiator concentration, and the polymerization temperature.

The degree of crosslinking in the polymer may be tuned by adjusting the monomer ratio. The chain length of the polymers in the polymeric network and, therefore, the degree of crosslinking may also be controlled by using specific monomers that impart specific physicochemical properties to the final polymer and membrane. These “tuning” monomers can affect the interaction of the polymer chain with the solvent system. Moreover, the hydrophilicity/hydrophobicity of these monomers can affect the final aqueous swelling properties of the resultant gel and the hydrophilic/hydrophobic surface properties of the polymer network.

To minimize forming composite materials without pores, the solvent system and monomer are selected to ensure an adequate driving force exists to exclude the growing polymer chains from solution at a certain point, thereby forming macropores. Specifically, the mixture of solvents and non-solvents is tuned to provide a suitable reaction system that can initially dissolve all of reactants but serves as a poor solvent for the cross-linked polymer chains as they grow to be larger than a certain molecular weight. A solvent system with too high a proportion of poor solvent (for the polymer chains) can lead to a rapid precipitation of growing polymer chains, which decreases porosity. The size of the macropores is generally dependent on the nature and concentration of the cross-linking agent, the nature of the solvent or solvents in which the gel is formed, the amount of any polymerization initiator or catalyst and, if present, the nature and concentration of porogen. In certain embodiments, the composite material may have a narrow pore-size distribution.

In some embodiments, the macroporous cross-linked gel forms as a result of phase separation during the free-radical cross-linking polymerization of polymerizable monomers in the presence of an inert diluent. In some embodiments, the reaction system comprises a polymer network, soluble polymers, and low molecular compounds (monomers and diluent) to form macroporous cross-linked polymers. In some embodiments, the macroporous cross-linked gel swells only slightly in solvents.

In general, many highly porous and non-rigid polymeric materials are relatively weak and are unable to withstand the pressures generated during typical membrane separation processes (e.g., liquid chromatography). Therefore, in order to make membranes that are mechanically suitable, in certain embodiments a composite material comprising both a porous substrate (such as a woven substrate made of the chemically inert polypropylene) and a porous cross-linked polymer is produced by synthesizing the polymer directly within the substrate pores.

In certain embodiments, when examined using environmental scanning electron microscopy (ESEM), the composite materials showed a well-connected gel network that is incorporated within the substrate fibers.

In some embodiments, the formation of high polymer density regions, which is also referred to as bundling or lateral aggregation of the polymer chains, leaves macropores between regions of high polymer density. In some embodiments, a macroporous cross-linked gel has a hetergenous appearance.

In certain embodiments, the composite materials used as membranes in the present invention are described in U.S. Pat. Nos. 7,316,919; 8,206,958; 8,187,880; 8,211,682; 8,652,849; 8,192,971; 8,206,982; 8,367,809; 8,383,782; 8,133,840; 9,962,691; and 10,357,766; and U.S. patent application Ser. Nos. 14/190,650, 16/055,786, and 16/516,500; all of which are hereby incorporated by reference.

In certain embodiments, the invention relates to any one of the methods disclosed herein, wherein the functionalized composite material comprises
i. a support member comprising a plurality of pores extending through the support member; and
ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member.

In certain embodiments, the invention relates to any one of the methods disclosed herein, wherein the macroporous cross-linked gel of the composite material has macropores of average diameter of about 5 nm to about 10,000 nm. In certain embodiments, the macroporous cross-linked gel has macropores of average diameter between about 10 nm to about 3000 nm. In certain embodiments, the macroporous cross-linked gel has macropores of average diameter between about 25 nm and about 1500 nm. In certain embodiments, the macroporous cross-linked gel has macropores of average diameter between about 50 nm and about 1000 nm. In certain embodiments, the macroporous cross-linked gel has macropores of average diameter of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, or about 700 nm.

In certain embodiments, the diameter of the macropores is estimated by one of the techniques described herein. In certain embodiments, the diameter of the macropores is calculated by capillary flow porometry. Because only the maximum porosity is a characteristic property for a given material, it is appropriate to define the macroporosity with respect to the maximum porosity.

In certain embodiments, the invention relates to any one of the methods disclosed herein, wherein the macroporous cross-linked gel of the composite material is a neutral hydrogel, a charged hydrogel, a polyelectrolyte gel, a hydrophobic gel, a neutral gel, or a gel comprising functional groups. In certain embodiments, the invention relates to any one of the methods disclosed herein, wherein the macroporous cross-linked gel of the composite material is a neutral or charged hydrogel; and the neutral or charged hydrogel is selected from the group consisting of cross-linked poly(vinyl alcohol), poly(acrylamide), poly(isopropylacrylamide), poly(vinylpyrrolidone), poly(hydroxymethyl acrylate), poly(ethylene oxide), copolymers of acrylic acid or methacrylic acid with acrylamide, isopropylacrylamide, or vinylpyrrolidone, copolymers of acrylamide-2-methyl-1-propanesulfonic acid with acrylamide, isopropylacrylamide, or vinylpyrrolidone, copolymers of (3-acrylamido-propyl) trimethylammonium chloride with acrylamide, isopropylacrylamide, or N-vinyl-pyrrolidone, and copolymers of diallyldimethylammonium chloride with acrylamide, isopropylacrylamide, or vinylpyrrolidone. In certain embodiments, the invention relates to any one of the methods disclosed herein, wherein the macroporous cross-linked gel of the composite material is a polyelectrolyte gel; and the polyelectrolyte gel is selected from the group consisting of cross-linked poly(acrylamido-2-methyl-1-propanesulfonic acid) and its salts, poly(acrylic acid) and its salts, poly(methacrylic acid) and its salts, poly(styrenesulfonic acid) and its salts, poly(vinylsulfonic acid) and its salts, poly(alginic acid) and its salts, poly[(3-acrylamidopropyl)trimethylammonium] salts, poly(diallyldimethylammonium) salts, poly(4-vinyl-N-methylpyridinium) salts, poly(vinylbenzyl-N-trimethylammonium) salts, and poly(ethyleneimine) and its salts. In certain embodiments, the invention relates to any one of the methods disclosed herein, wherein the macroporous cross-linked gel of the composite material is a hydrophobic gel; and the hydrophobic gel is selected from the group consisting of cross-linked polymers or copolymers of ethyl acrylate, n-butyl acrylate, propyl acrylate, octyl acrylate, dodecyl acrylate, octadecylacrylamide, stearyl acrylate, and styrene. In certain embodiments, the invention relates to any one of the methods disclosed herein, wherein the macroporous cross-linked gel of the composite material is a neutral gel; and the neutral gel is selected from the group consisting of cross-linked polymers or copolymers of acrylamide, N,N-dimethylacrylamide, N-methacryloylacrylamide, N-methyl-N-vinylacetamide, and N-vinylpyrrolidone.

In certain embodiments, the cross-linked composite materials (e.g., membranes) are further grafted with chemical functional groups or molecular species to provide a functionalized composite material. In certain embodiments, the cross-linked polymer may be functionalized by post-polymerization modification to form a functionalized composite material. In certain embodiments, functionalized composite material comprising the functionalized cross-linked polymer may be coupled to a ligand by post-polymerization modification. In this two-step method, the excess pendant reactive functional groups are modified during a separate grafting step, e.g., excess thiol or alkene groups generated during the thiol-alkene polymerization. By controlling the monomer and cross-linker feed ratio, the final polymers can have a surplus of pendant reactive functional groups. The pendant reactive functional groups of the functionalized composite material can be used subsequently in a coupling reaction, such as a click reaction, to further modify the final polymer chemistry or functionality. In certain embodiments, the cross-linked polymers in the composite material contain residual reactive groups, referred to as pendant reactive functional groups, such as thiols or unsaturated carbon-carbon bonds, that may be used to attach various ligands via coupling reactions. In certain embodiments, this approach is useful in making polymeric composite materials (e.g., membranes) that contain various ligands useful for chromatography. For example, chromatographic separation of biomolecules (e.g., proteins). For example, this approach can be used to introduce to the composite materials (e.g., membrane) ion exchange functionalities (e.g., carboxylate, sulfonate, quaternary ammonium, amine), hydrophobic interaction moieties (such as octyl group by using 1-octanethiol or 1-octene), and biomolecules for bio-affinity chromatography (such as cysteine-protein A for monoclonal antibody purification).

In some embodiments, the composite materials display high selectivity and high flow velocity, low back pressure, be inexpensive, and allow for long column-lifetimes, short process-times, and overall operational flexibility.

In certain embodiments, the invention relates to any one of the aforementioned composite materials, wherein the composite material is a membrane.

In certain embodiments, the invention relates to any one of the aforementioned composite materials, wherein the composite material has a water contact angle from about 500 to about 120°.

Porous Support Member

In some embodiments, the support member has a void volume; and the void volume of the support member is substantially filled with the macroporous cross-linked gel. In some embodiments, the porous support member has a volume porosity of about 40% to about 90%. In some embodiments, the porous support member has a volume porosity of about 50% to about 80%. In some embodiments, the porous support member has a volume porosity of about 50%, about 60%, about 70%, or about 80%.

In certain embodiments, the porous support is flat.

In certain embodiments, the porous support is disk-shaped.

Many porous substrates or membranes can be used as the support member. In some embodiments, the porous support member is made of polymeric material. In certain embodiments, the support may be a polyolefin, which is available at low cost. In certain embodiments, the polyolefin may be poly(ethylene), poly(propylene), or poly(vinylidene difluoride). Extended polyolefin membranes made by thermally induced phase separation (TIPS), or non-solvent induced phase separation are mentioned. In certain embodiments, the support member may be made from natural polymers, such as cellulose or its derivatives. In certain embodiments, suitable supports include polyethersulfone membranes, poly(tetrafluoroethylene) membranes, nylon membranes, cellulose ester membranes, fiberglass, or filter papers. In some embodiments, the support member comprises a polymeric material selected from the group consisting of polysulfones, polyethersulfones, polyphenyleneoxides, polycarbonates, polyesters, cellulose and cellulose derivatives.

In certain embodiments, the porous support is composed of woven or non-woven fibrous material, for example, a polyolefin, such as polypropylene. Such fibrous woven or non-woven support members can have pore sizes larger than the TIPS support members, in some instances up to about 75 μm. The larger pores in the support member permit formation of composite materials having larger macropores in the macroporous gel. Non-polymeric support members can also be used, such as ceramic-based supports. The porous support member can take various shapes and sizes.

In some embodiments, the support member is in the form of a membrane.

In some embodiments, the support member has a thickness from about 10 to about 2000 μm, from about 10 to about 1000 μm, or from about 10 to about 500 μm. In some embodiments, the support member has a thickness from about 30 μm to about 300 μm. In some embodiments, the thickness of the support member is about 30 μm, about 50 μm, about 100 μm, about 150 μm, about 200 μm, about 250 μm, or about 300 μm.

In some embodiments, the pores of the support member have an average pore diameter of about 0.1 μm to about 50 μm. In some embodiments, the pores of the support member have an average pore diameter of about 0.1 μm to about 25 μm. In some embodiments, the pores of the support member have an average pore diameter of about 0.5 μm to about 15 μm. In some embodiments, the pores of the support member have an average pore diameter of about 0.5 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, or about 15 μm.

In other embodiments, multiple porous support units can be combined, for example, by stacking. In one embodiment, a stack of porous support membranes, for example, from 2 to 10 membranes, can be assembled before the gel is formed within the void of the porous support. In another embodiment, single support member units are used to form composite material membranes, which are then stacked before use.

Relationship Between Gel and Support Member

The gel may be anchored within the support member. The term “anchored” is intended to mean that the gel is held within the pores of the support member, but the term is not necessarily restricted to mean that the gel is chemically bound to the pores of the support member. The gel can be held by the physical constraint imposed upon it by enmeshing and intertwining with structural elements of the support member, without actually being chemically grafted to the support member, although in some embodiments, the gel may be grafted to the surface of the pores of the support member.

In certain embodiments, the cross-linked gels are macroporous. In these instances, because the macropores are present in the gel that occupies the pores of the support member, the macropores of the gel must be smaller than the pores of the support member.

Consequently, the flow characteristics and separation characteristics of the composite material are dependent on the characteristics of the gel, but are largely independent of the characteristics of the porous support member, with the proviso that the size of the pores present in the support member is greater than the size of the macropores of the gel. The porosity of the composite material can be tailored by filling the support member with a gel whose porosity is partially or completely dictated by the nature and amounts of monomer or polymer, cross-linking agent, reaction solvent, and porogen, if used. Properties of the composite material are determined partially, if not entirely, by the properties of the gel. The net result is that the invention provides control over macropore-size, permeability and surface area of the composite materials.

When present, the number of macropores in the composite material is not dictated by the number of pores in the support material. The number of macropores in the composite material can be much greater than the number of pores in the support member because the macropores are smaller than the pores in the support member. As mentioned above, the effect of the pore-size of the support material on the pore-size of the macroporous gel is generally negligible. An exception is found in those cases where the support member has a large difference in pore-size and pore-size distribution, and where a macroporous gel having very small pore-sizes and a narrow range in pore-size distribution is sought. In these cases, large variations in the pore-size distribution of the support member are weakly reflected in the pore-size distribution of the macroporous gel. In certain embodiments, a support member with a somewhat narrow pore-size range may be used in these situations.

In certain embodiments, the invention relates to any one of the aforementioned composite materials, wherein the composite materials are relatively non-toxic.

Preparation of Composite Materials

In certain embodiments, the composite materials of the invention may be prepared by single-step methods. In certain embodiments, these methods may use water or other environmentally benign solvents as the reaction solvent. In certain embodiments, the methods may be rapid and, therefore, may lead to simple and/or rapid manufacturing processes. In certain embodiments, preparation of the composite materials may be inexpensive.

In certain embodiments, the composite materials may be prepared by mixing a monomer or monomers, a cross-linking agent or agents, an initiator or initiators, and optionally one or more porogens, in one or more suitable solvents. In certain embodiments, the resulting mixture may be homogeneous. In certain embodiments, the mixture may be heterogeneous. In certain embodiments, the mixture may then be introduced into a suitable porous support, where a gel forming reaction may take place.

In certain embodiments, a porogen may be added to the reactant mixture, wherein porogens may be broadly described as pore-generating additives. In certain embodiments, the porogen may be selected from the group consisting of thermodynamically poor solvents and extractable polymers (e.g., poly(ethyleneglycol)), surfactants, and salts.

In some embodiments, the gel forming reaction must be initiated. In certain embodiments, the gel forming reaction may be initiated by any known method, for example, through thermal activation or exposure to UV radiation. In certain embodiments, the reaction may be initiated by UV radiation in the presence of a photoinitiator. In certain embodiments, the photoinitiator may be selected from the group consisting of 2-hydroxy-1-[4-(2-hydroxyethoxy)phenyl]-2-methyl-1-propanone (Irgacure 2959), 4,4′-azobis(4-cyanovaleric acid) (ACVA), 2,2-dimethoxy-2-phenylacetophenone (DMPA), benzophenone, benzoin and benzoin ethers, such as benzoin ethyl ether and benzoin methyl ether, dialkoxyacetophenones, hydroxyalkylphenones, and α-hydroxymethyl benzoin sulfonic esters. Thermal activation may require the addition of a thermal initiator. In certain embodiments, the thermal initiator may be selected from the group consisting of 1,1′-azobis(cyclohexanecarbonitrile) (VAZO© catalyst 88), azobis(isobutyronitrile) (AIBN), potassium persulfate, ammonium persulfate, and benzoyl peroxide.

In certain embodiments, the gel-forming reaction may be initiated by UV radiation. In certain embodiments, a photoinitiator may be added to the reactants of the gel forming reaction, and the support member containing the mixture of monomer, cross-linking agent, and photoinitiator may be exposed to UV radiation at wavelengths from about 250 nm to about 400 nm for a period of a few seconds to a few hours. In certain embodiments, the support member containing the mixture of monomer, cross-linking agent, and photoinitiator may be exposed to UV radiation at about 350 nm for a period of a few seconds to a few hours. In certain embodiments, the support member containing the mixture of monomer, cross-linking agent, and photoinitiator may be exposed to UV radiation at about 350 nm for about 10 minutes. In certain embodiments, visible wavelength light may be used to initiate the polymerization. In certain embodiments, the support member must have a low absorbance at the wavelength used so that the energy may be transmitted through the support member.

In certain embodiments, the rate at which polymerization is carried out may have an effect on the size of the macropores obtained in the macroporous gel. In certain embodiments, when the concentration of cross-linker in a gel is increased to sufficient concentration, the constituents of the gel begin to aggregate to produce regions of high polymer density and regions with little or no polymer, which latter regions are referred to as “macropores” in the present specification. This mechanism is affected by the rate of polymerization.

In certain embodiments, once the composite materials are prepared, they may be washed with various solvents to remove any unreacted components and any polymer or oligomers that are not anchored within the support. In certain embodiments, solvents suitable for the washing of the composite material include water, acidic (e.g., HCl) or basic (e.g., NaOH) aqueous solution, aqueous salt solutions (e.g., NaCl), acetone, methanol, ethanol, propanol, and DMF.

Exemplary Methods for CouplingLigands to Functionalized Composite Materials Methods for coupling a ligand to a functionalized composite material by flowing a first solution comprising the ligand across or through the functionalized composite material are provided herein.

In one aspect, the invention relates to methods for coupling a ligand to a functionalized composite material, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member; and
b. flowing at a first flow rate a first solution substantially through or substantially across the functionalized composite material, wherein the first solution comprises a plurality of first ligands, such that a plurality of covalent bonds forms between the reactive functional groups and the first ligands;

wherein the functionalized composite material is arranged in a coplanar stack of coextensive sheets, a tubular configuration, or a spiral wound configuration.

In certain embodiments, the invention relates to providing any one of the aforementioned functionalized composite materials.

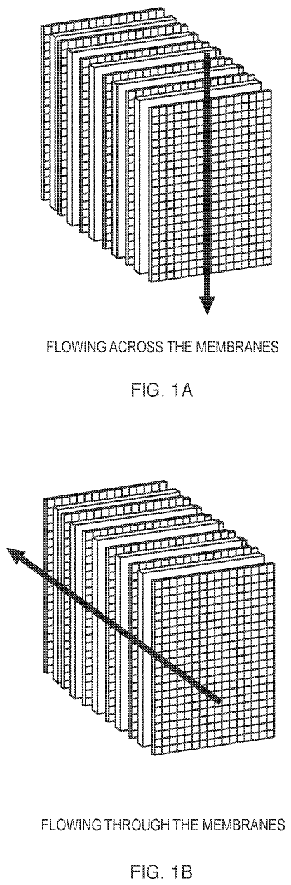

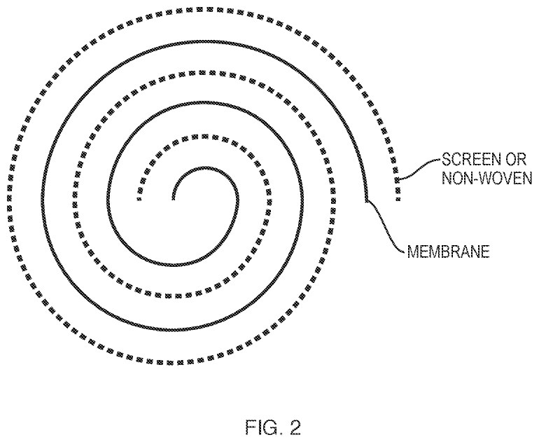

In certain embodiments, the invention relates to any one of the aforementioned methods, wherein the first solution flows substantially across the functionalized composite material. In some embodiments, the fluid flow path is tangential to the surface of the functionalized composite material (FIG. 1A). In some embodiments, tangential flow provides a lower pressure drop and/or allows stacks composed of many layers of composite material to be coupled simultaneously.

In certain embodiments, the invention relates to any one of the aforementioned methods, wherein the first solution flows substantially through the functionalized composite material. In some embodiments, the fluid flow path is directly through the functionalized composite material (FIG. 1i). In some embodiments, direct flow provides an increasing pressure drop as the number of layers of composite material increases. In some embodiments, the pressure drop limits the number of layers in a stack. In some embodiments, one or more layers of interleaf act to distribute flow. In some embodiments, direct flow increases the rate of mass transfer of a ligand into the porous composite material structure.

In certain embodiments, the cross-linked macroporous gels are further grafted with chemical functional groups or molecular species to provide a functionalized composite material. In certain embodiments, the cross-linked polymer may be functionalized by post-polymerization modification to form a functionalized composite material. In this two-step method, the excess pendant reactive functional groups are modified during a separate grafting step, e.g., excess thiol or alkene groups generated during the thiol-alkene polymerization. By controlling the monomer and cross-linker feed ratio, the final polymers can have a surplus of pendant reactive functional groups.

In certain embodiments, the invention relates to any one of the aforementioned methods, wherein the pendant reactive functional groups are selected from the group consisting of aldehydes, amines, carbon-carbon double bonds, carbon-carbon triple bonds, epoxides, hydroxyls, thiols, anhydrides, azides, reactive halogens, acid chlorides, and a mixture thereof.

In some embodiments of the methods, the pendant reactive functional groups are selected from the group consisting of carbon-carbon double bonds, carbon-carbon triple bonds, and thiols. In some embodiments, the pendant reactive functional groups are derived from a molecule comprising a thiol functional group or a molecule comprising an unsaturated carbon-carbon bond. In some embodiments, the pendant reactive functional groups are derived from a molecule comprising a thiol functional group; and the molecule comprising a thiol functional group is selected from the group consisting of 3-mercaptopropionic acid, 1-mercaptosuccinic acid, a polypeptide comprising a cysteine residue, a protein comprising a cysteine residue, a recombinant protein comprising a cysteine residue, a bacterial immunoglobulin-binding protein comprising a cysteine residue, a recombinant fusion protein comprising a cysteine residue, cysteamine, 1-thiohexitol, poly(ethylene glycol) 2-mercaptoethyl ether acetic acid, poly(ethylene glycol) methyl ether thiol, 1-thioglycerol, 2-naphthalenethiol, biphenyl-4-thiol, 3-amino-1,2,4-triazole-5-thiol, 5-(trifluoromethyl)pyridine-2-thiol, 1-[2-(dimethylamino)ethyl]-1H-tetrazole-5-thiol, 1-propanethiol, 1-butanethiol, 1-pentanethiol, 1-hexanethiol, 1-octanethiol, 8-amino-1-octanethiol hydrochloride, 3,3,4,4,5,5,6,6,7,7,8,8,8-tridecafluoro-1-octanethiol, 8-mercapto-1-octanol, and 7-Glu-Cys.

In some embodiments, the molecule comprising a thiol functional group is selected from the group consisting of a polypeptide comprising a cysteine residue, a protein comprising a cysteine residue, a recombinant protein comprising a cysteine residue, a bacterial immunoglobulin-binding protein comprising a cysteine residue, and a recombinant fusion protein comprising a cysteine residue. In some embodiments, the molecule comprising a thiol functional group is a protein comprising a cysteine residue.

In some embodiments, the pendant reactive functional groups are derived from a molecule comprising an unsaturated carbon-carbon bond; and the molecule comprising an unsaturated carbon-carbon bond is selected from the group consisting of 1-octene, 1-hexyne, 4-bromo-1-butene, allyldiphenylphosphine, allylamine, allyl alcohol, 3,4-dihydroxy-1-butene, 7-octene-1,2-diol, 3-allyloxy-1,2-propanediol, 3-butenoic acid, 3,4-dehydro-L-proline, vinyl laurate, 1-vinyl-2-pyrrolidinone, vinyl cinnamate, an acylamide, or an acrylate.

In some embodiments, the pendant reactive functional groups are selected from the group consisting of acid chlorides, acyl azides, aldehydes, amines, anhydrides, azides, carbonates, carbon-carbon double bonds, carbon-carbon triple bonds, carboniimides, carboxylic acids, disulfides, epoxides, fluorobenzenes, fluorophenyl esters, haloacetyls, hydroxyls, imidoesters, isocyanates, isothiocyanates, maleimides, N-hydroxysuccinimide esters, pyridyl disulfide, reactive esters, reactive halogens, sulfonyl halides, thiols, and -thiosulfates. In some embodiments, the pendant reactive functional groups are selected from the group consisting of aldehydes, amines, epoxides, hydroxyls, anhydrides, azides, reactive halogens, and acid chlorides. In some embodiments, the pendant reactive functional groups are selected from the group consisting of aldehydes, amines, epoxides, and hydroxyls. In some embodiments, the pendant reactive functional groups are selected from the group consisting of epoxides, aldehydes, carboxylic acids, reactive halogens, reactive esters, isocyanates, isothiocyanates, sulfonyl halides, carbodiimides, acyl azides, fluorobenzenes, carbonates, N-hydroxysuccinimide esters, imidoesters, and fluorophenyl esters. In some embodiments, the pendant reactive functional groups are selected from the group consisting of epoxides, aldehydes, carboxylic acids, reactive halogens, reactive esters, isocyanates, isothiocyanates, sulfonyl halides, carboniimides, acyl azides, fluorobenzenes, carbonates, N-hydroxysuccinimide esters, imidoesters, and fluorophenyl esters and react with an amine group. In some embodiments, the pendant reactive functional groups are selected from the group consisting of epoxides, thiols, disulfides, carbon-carbon double bonds, carbon-carbon triple bonds, maleimides, haloacetyls, pyridyl disulfide, thiosulfates, and reactive halogens. In some embodiments, the pendant reactive functional groups are selected from the group consisting of epoxides, thiols, disulfides, carbon-carbon double bonds, carbon-carbon triple bonds, maleimides, haloacetyls, pyridyl disulfide, thiosulfates, and reactive halogens.

In some embodiments, the one or more monomers comprising a pendant reactive functional group are selected from the group consisting of glycidyl methacrylate, acrylamidoxime, acrylic anhydride, azelaic anhydride, maleic anhydride, hydrazide, acryloyl chloride, 2-bromoethyl methacrylate, and vinyl methyl ketone.

In some embodiments, the pendant reactive functional groups are aldehydes. In some embodiments, the one or more monomers comprising a pendant reactive functional group is vinyl methyl ketone.

In some embodiments, the pendant reactive functional groups are amines.

In some embodiments, the pendant reactive functional groups are epoxides. In some embodiments, the one or more monomers comprising a pendant reactive functional group is glycidyl methacrylate.

In some embodiments, the pendant reactive functional groups are hydroxyls.

In some embodiments, the first ligand comprises a first functionality. In some embodiments, the first ligand further comprises at least one grafting end-group; and the first functionality is selected from the group consisting of cationic, anionic, hydrophobic, hydrophilic, thiophilic, hydrogen bond donating, hydrogen bond accepting, pi-pi bond donating, pi-pi bond accepting, metal chelating, a biological molecule, and a biological ion. In some embodiments, the first functionality is selected from the group consisting of cationic, anionic, hydrophobic, hydrophilic, thiophilic, hydrogen bond donating, hydrogen bond accepting, pi-pi bond donating, and pi-pi bond accepting.

In some embodiments, the individual functionalities are included through the incorporation of functional monomers. In some embodiments, the relative amount of each functional group can be easily and readily tuned for optimal performance characteristics.

In some embodiments, a molecule comprises a first functionality, and the molecule is selected from the group consisting of 2-(diethylamino)ethyl methacrylate, 2-aminoethyl methacrylate, 2-carboxyethyl acrylate, 2-(methylthio)ethyl methacrylate, acrylamide, N-acryloxysuccinimide, butyl acrylate or methacrylate, N,N-diethylacrylamide, N,N-dimethylacrylamide, 2-(N,N-dimethylamino)ethyl acrylate or methacrylate, N-[3-(N,N-dimethylamino)propyl]methacryl-amide, N,N-dimethylacrylamide, ethyl acrylate or methacrylate, 2-ethylhexyl methacrylate, hydroxypropyl methacrylate, glycidyl acrylate or methacrylate, ethylene glycol phenyl ether methacrylate, methacrylamide, methacrylic anhydride, propyl acrylate or methacrylate, N-isopropylacrylamide, styrene, 4-vinylpyridine, vinylsulfonic acid, N-vinyl-2-pyrrolidinone (VP), acrylamido-2-methyl-1-propanesulfonic acid, styrenesulfonic acid, alginic acid, (3-acrylamidopropyl)trimethylammonium halide, diallyldimethylammonium halide, 4-vinyl-N-methylpyridinium halide, vinylbenzyl-N-trimethylammonium halide, methacryloxyethyltrimethylammonium halide, 3-sulfopropyl methacrylate, 2-(2-methoxy)ethyl acrylate or methacrylate, hydroxyethyl acrylamide, N-(3-methoxypropyl acrylamide), N-[tris(hydroxymethyl)methyl]acrylamide, N-phenyl acrylamide, N-tert-butyl acrylamide, or diacetone acrylamide.

In some embodiments, the first functionality is a metal chelating functionality. In some embodiments, the first functionality comprises a metal chelating functionality selected from the group consisting of octadentate, hexadentate, tetradentate, tridentate, bidentate, iminodicarboxylic acid, iminodiacetic acid, and salts of iminodiacetic acid.

In some embodiments, the metal chelating functionality is complexed to a plurality of metal ions. In some embodiments, the metal chelating functionality is selected from the group consisting of iminodicarboxylic acid, iminodiacetic acid, and salts of iminodiacetic acid complexed to a plurality of metal ions selected from the group consisting of transition metal ions, lanthanide ions, poor metal ions, and alkaline earth metal ions. In some embodiments, the metal chelating functionality is selected from the group consisting of iminodicarboxylic acid, iminodiacetic acid, and salts of iminodiacetic acid complexed to a plurality of metal ions selected from the group consisting of nickel, zirconium, lanthanum, cerium, manganese, titanium, cobalt, iron, copper, zinc, silver, gallium, platinum, palladium, lead, mercury, cadmium and gold. In some embodiments, the metal chelating functionality is iminodiacetic acid or salts of iminodiacetic acid complexed to a plurality of metal ions, wherein the metal ions are nickel or zirconium.

In some embodiments, the first functionality is a biological molecule or a biological ion. In some embodiments, the first functionality comprises a biological molecule or a biological ion functionality selected from the group consisting of albumins, lysozyme, viruses, cells, γ-globulins of human and animal origins, immunoglobulins of both human and animal origins, proteins of recombinant or natural origin including, polypeptides of synthetic or natural origin, interleukin-2 and its receptor, enzymes, monoclonal antibodies, antigens, lectins, bacterial immunoglobulin-binding proteins, trypsin and its inhibitor, cytochrome C, myoglobulin, recombinant human interleukin, recombinant fusion protein, Protein A, Protein G, Protein L, Peptide H, nucleic acid derived products, DNA of either synthetic or natural origin, and RNA of either synthetic or natural origin. In some embodiments, the first functionality comprises a biological molecule or a biological ion functionality selected from the group consisting of γ-globulins of human and animal origins, immunoglobulins of both human and animal origins, proteins of recombinant or natural origin including, polypeptides of synthetic or natural origin, monoclonal antibodies, bacterial immunoglobulin-binding proteins, recombinant fusion protein, Protein A, Protein G, and Protein L. In certain embodiments, the first functionality comprises a biological molecule or a biological ion functionality selected from the group consisting of a polypeptide, a protein, a recombinant protein, a bacterial immunoglobulin-binding protein, a recombinant fusion protein, Protein A, Protein G, Protein L, and Peptide H.

In some embodiments, the first functionality comprises Protein A. In some embodiments, the first functionality comprises Protein A, including a Protein A derivative and recombinant Protein A, selected from the group consisting of a polypeptide comprising a cysteine residue, a protein comprising a cysteine residue, a recombinant protein comprising a cysteine residue, a bacterial immunoglobulin-binding protein comprising a cysteine residue, a recombinant fusion protein comprising a cysteine residue. In some embodiments, the first functionality comprises Protein A selected from the group consisting of a protein, peptide, or recombinant protein comprising a ligand that binds monoclonal antibodies (e.g., IgG antibodies) and a moiety that can form a covalent bond with a pendant reactive functional group. In some embodiments, the first functionality comprises Protein A selected from the group consisting of a protein, peptide, or recombinant protein comprising a ligand that binds with the Fc domain of an antibody and a moiety that can form a covalent bond with a pendant reactive functional group. In some embodiments, the first functionality comprises Protein A selected from the group consisting of a protein, peptide, or recombinant protein comprising a ligand that binds with the Fab domain of an antibody and a moiety that can form a covalent bond with a pendant reactive functional group.

In some embodiments, the first ligand comprises a first functionality and at least one grafting end-group selected from the group consisting of an aldehyde, an amine, a carbon-carbon double bond, a carbon-carbon triple bond, an epoxide, a hydroxyl, a thiol, and a mixture thereof. In some embodiments, the at least one grafting end-group is an aldehyde. In some embodiments, the at least one grafting end-group is an amine. In some embodiments, the at least one grafting end-group is a carbon-carbon double bond or a carbon-carbon triple bond. In some embodiments, the at least one grafting end-group is an epoxide. In some embodiments, the at least one grafting end-group is a hydroxyl. In some embodiments, the at least one grafting end-group is a thiol.

In certain embodiments, thiol-ene grafting is an attractive option for attaching biomolecules to the cross-linked polymer of the membrane. The reaction is fast, can be carried out efficiently in aqueous media, works well at room temperature, and can be photo-initiated using a relatively long wavelength light (365 nm), which has very limited effect on protein bioactivity. In addition, it can allow for controlled biomolecule attachment, which can be advantageous in terms of preserving bioactivity and 3D structure of the biomolecule. In certain embodiments, it is possible to immobilize onto the composite materials described herein any biomolecule that has free thiol functionality. This can be very useful in making bio-affinity membranes for bioseparation or bio-catalysis membranes (by immobilizing enzyme(s)). In certain embodiments, the composite materials may be functionalized with oligonucleotide probes for DNA detection.

In certain embodiments, the invention relates to any one of the aforementioned methods, further comprising the step of:
c. flowing at a second flow rate a first wash solution substantially through or substantially across the composite material, thereby removing excess first ligand.

In certain embodiments, the invention relates to any one of the aforementioned methods, further comprising the step of:
d. flowing at a third flow rate a quenching solution substantially through or substantially across the composite material, wherein the quenching solution comprises a reactive compound to convert any residual pendant reactive functional groups to non-reactive groups; and
e. optionally, flowing at a fourth flow rate a second wash solution substantially through or substantially across the composite material to remove any residual reactive compound.

In some embodiments, the first solution of step b. is recirculated through or across the composite material.

In some embodiments, the quenching solution of step d. is recirculated through or across the composite material.

In certain embodiments, the invention relates to any one of the aforementioned methods, further comprising the step of:
c. optionally, flowing at a second flow rate a first wash solution substantially through or substantially across the composite material to remove any excess first ligand;
d. flowing at a third flow rate a second solution substantially through or substantially across the functionalized composite material, wherein the second solution comprises a plurality of second ligands comprising at least three reactive groups, wherein the second ligand is a cross-linker, and, optionally, a polymerizable monomer comprising at least two pendant reactive functional groups, thereby forming a plurality of covalent bonds between the reactive functional groups and the second ligands.

In some embodiments, the second ligand is added in at least two portions. In some embodiments, the polymerizable monomer comprising at least two pendant reactive functional groups is added in at least two portions.

In some embodiments, the second ligand comprises a second functionality. In some embodiments, the second ligand further comprises at least one grafting end-group; and the second functionality is selected from the group consisting of cationic, anionic, hydrophobic, hydrophilic, thiophilic, hydrogen bond donating, hydrogen bond accepting, pi-pi bond donating, pi-pi bond accepting, metal chelating, a biological molecule, and a biological ion. In some embodiments, the second functionality is selected from the group consisting of cationic, anionic, hydrophobic, hydrophilic, thiophilic, hydrogen bond donating, hydrogen bond accepting, pi-pi bond donating, and pi-pi bond accepting.

In some embodiments, the second ligand comprises a biological molecule or a biological ion comprising at least one grafting end-group selected from the group consisting of an amine, a hydroxyl, and a thiol functional group. In some embodiments, the biological molecule or the biological ion is selected from the group consisting of albumins, lysozyme, viruses, cells, γ-globulins of human and animal origins, immunoglobulins of both human and animal origins, proteins of recombinant or natural origin including, polypeptides of synthetic or natural origin, interleukin-2 and its receptor, enzymes, monoclonal antibodies, antigens, lectins, bacterial immunoglobulin-binding proteins, trypsin and its inhibitor, cytochrome C, myoglobulin, recombinant human interleukin, recombinant fusion protein, Protein A, Protein G, Protein L, Peptide H, nucleic acid derived products, DNA of either synthetic or natural origin, and RNA of either synthetic or natural origin. In some embodiments, the biological molecule or the biological ion is selected from the group consisting of γ-globulins of human and animal origins, immunoglobulins of both human and animal origins, proteins of recombinant or natural origin including, polypeptides of synthetic or natural origin, monoclonal antibodies, antigens, bacterial immunoglobulin-binding proteins, recombinant fusion protein, Protein A, Protein G, Protein L, and Peptide H. In some embodiments, the second ligand is a polypeptide, a protein, a recombinant protein, a bacterial immunoglobulin-binding protein, a recombinant fusion protein, Protein A, Protein G, Protein L, and Peptide H.

In some embodiments, the first ligand and the second ligand are the same. In some embodiments, the first ligand and the second ligand are different.

In some embodiments, the polymerizable monomer comprising at least two pendant reactive functional groups is poly(ethylene glycol) divinyl ether.

In certain embodiments, the invention relates to any one of the aforementioned methods, further comprising the step of:
e. flowing at a fourth flow rate a second wash solution substantially through or substantially across the composite material to remove any excess second ligand and, optionally, any excess polymerizable monomer.

In certain embodiments, the invention relates to any one of the aforementioned methods, further comprising the step of:
f. flowing at a fifth flow rate a quenching solution substantially through or substantially across the composite material, wherein the quenching solution comprises a reactive compound to convert any residual pendant reactive functional groups to non-reactive groups; and
g. optionally, flowing at a sixth flow rate a third wash solution substantially through or substantially across the composite material to remove any residual reactive compound.

In some embodiments, the invention relates to methods for coupling a ligand to a functionalized composite material, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member;
b. flowing at a first flow rate a first solution substantially through or substantially across the functionalized composite material, wherein the first solution comprises a plurality of first ligands, such that a plurality of covalent bonds forms between the reactive functional groups and the first ligands;
c. optionally, flowing at a second flow rate a first wash solution substantially through or substantially across the composite material to remove any excess first ligand;
d. flowing at a third flow rate a quenching solution substantially through or substantially across the composite material, wherein the quenching solution comprises a reactive compound to convert any residual pendant reactive functional groups to non-reactive groups; and
e. optionally, flowing at a fourth flow rate a second wash solution substantially through or substantially across the composite material to remove any residual reactive compound;

wherein the functionalized composite material is arranged in a coplanar stack of coextensive sheets, a tubular configuration, or a spiral wound configuration.

In some embodiments, the invention relates to methods for coupling a ligand to a functionalized composite material, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member;
b. flowing at a first flow rate a first solution substantially through or substantially across the functionalized composite material, wherein the first solution comprises a plurality of first ligands, such that a plurality of covalent bonds forms between the reactive functional groups and the first ligands;
c. optionally, flowing at a second flow rate a first wash solution substantially through or substantially across the composite material to remove any excess first ligand;
d. flowing at a third flow rate a second solution substantially through or substantially across the functionalized composite material, wherein the second solution comprises a plurality of second ligands comprising at least three reactive groups, wherein the second ligand is a cross-linker, and, optionally, a polymerizable monomer comprising at least two pendant reactive functional groups, thereby forming a plurality of covalent bonds between the reactive functional groups and the second ligands;
e. optionally, flowing at a fourth flow rate a second wash solution substantially through or substantially across the composite material to remove any excess second ligand and, optionally, any excess polymerizable monomer;
f. flowing at a fifth flow rate a quenching solution substantially through or substantially across the composite material, wherein the quenching solution comprises a reactive compound to convert any residual pendant reactive functional groups to non-reactive groups; and
g. optionally, flowing at a sixth flow rate a third wash solution substantially through or substantially across the composite material to remove any residual reactive compound;

wherein the functionalized composite material is arranged in a coplanar stack of coextensive sheets, a tubular configuration, or a spiral wound configuration.

In some embodiments, the functionalized composite material is a wetted membrane.

In some embodiments, the wetted membrane is placed into a holder attached to a chromatography system. In some embodiments, the various solutions and fluids (e.g., the first solution, the first wash solution, the second solution, the quenching solution, the second wash solution, and the third wash solution) are pumped through a membrane holder.

In certain embodiments, the invention relates to any one of the aforementioned methods, wherein the functionalized composite material is arranged in a coplanar stack of coextensive sheets, a tubular configuration, or a spiral wound configuration.

Membrane Stacks

In some embodiments, the composite material is arranged in a substantially coplanar stack of substantially coextensive sheets. In some embodiments, the composite material has 2 to 300 separate support members. In some embodiments, the composite material has 5, 10, 15, 20, 25, 30, 35, 40, 45, 50, 55, 60, 65, 70, 75, 80, 85, 90, 95, 100, 105, 110, 115, 120, 125, 130, 35, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, or 300 separate support members. In some embodiments, the composite material has 5 to 200 separate support members. In some embodiments, the composite material has 5 to 100 separate support members.

In some embodiments, when the composite material is arranged in a substantially coplanar stack of substantially coextensive sheets, one or more separate support members are separated by one or more layers of interleaf. In some embodiments, the invention relates to any one of the aforementioned methods, wherein the layers of composite material and interleaf are alternating layers of composite material and interleaf (that is, (composite material−interleaf)ₓ or (interleaf−composite material)ₓ). In some embodiments, the composite material is layered with 1 to 250 separate layers of interleaf. In some embodiments, the composite material has 1 to 100 separate layers of interleaf. In some embodiments, the composite material has 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 separate layers of interleaf. In some embodiments, the composite material has 1 to 50 separate layers of interleaf. In some embodiments, the composite material has 1 to 25 separate layers of interleaf.

In some embodiments, the interleaf is a flow distributing layer. In some embodiments, the layer of interleaf extends beyond the edge of the layer of composite material. In some embodiments, the layer of interleaf allows flow through the membrane while also providing a lower pressure drop across the stack as the solution can also flow around the membranes.

In some embodiments, when the composite material is arranged in a substantially coplanar stack of substantially coextensive sheets, one or more separate support members, and, optionally, the one or more layers of interleaf are separated by one or more flow distributing layers. In some embodiments, the one or more flow distributing layers allow for even coupling within the stack. In some embodiments, the one or more flow distributing layers allow for more even coupling of a ligand to the composite materials throughout the stack compared to coupling without the flow distributing layers. In some embodiments, the composite material has 1 to 250 separate flow distributing layers. In some embodiments, the composite material has 1 to 100 separate flow distributing layers. In some embodiments, the composite material has 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 separate flow distributing layers. In some embodiments, the composite material has 1 to 50 separate flow distributing layers. In some embodiments, the composite material has 1 to 25 separate flow distributing layers.

In some embodiments, the one or more flow distributing layers are non-porous sheets.

In some embodiments, the one or more flow distributing layers are non-porous sheets containing a hole. In some embodiments, the flow distributing layers are distributed periodically within the membrane stack. In some embodiments, the flow distributing layers are distributed periodically within the membrane stack comprising layers of composite material and layers interleaf (that is, ((composite material−interleaf)ₓ(flow distributing)_{y} or (interleaf−composite material)ₓ(flow distributing)_{y}).

In some embodiments, the invention relates to any one of the aforementioned methods, wherein the support member comprises a polymeric material selected from the group consisting of polysulfones, polyethersulfones, polyphenyleneoxides, polycarbonates, polyesters, cellulose, and cellulose derivatives.

In some embodiments, the composite material is arranged in a tubular configuration.

Spiral Wound Configuration

In some embodiments, the composite material is arranged in a substantially spiral wound configuration. In some embodiments, the substantially spiral wound configuration comprises the composite material forming layers wrapped around an inner core. In some embodiments, the substantially spiral wound configuration comprises the composite material and interleaf wrapped around an inner core.

Interleaf of Spiral Wound Configuration

In some embodiments, the invention relates to any one of the aforementioned methods, wherein the layers of composite material and interleaf are alternating layers of composite material and interleaf (that is, (composite material−interleaf)ₓ or (interleaf−composite material)ₓ). In certain embodiments, the invention relates to any one of the above-mentioned methods, wherein the layers of composite material and interleaf are arranged (interleaf−first composite material−second composite material)ₓ or (first composite material−second composite material−interleaf). In certain embodiments, the invention relates to any one of the above-mentioned methods, wherein the layers of composite material and interleaf are arranged in a combination of the aforementioned arrangements. In certain embodiments, the first composite material and the second composite material are identical.

In some embodiments, the composite material comprises about 3 to about 50 layers of composite material around the inner core.

In some embodiments, the invention relates to any one of the aforementioned methods (e.g., a membrane stack or a spiral wound configuration), wherein the composite material is in contact with one or more interleaf layers. In some embodiments, the interleaf layers provide some mechanical support for the composite materials.

In some embodiments, the interleaf helps to reduce back pressure.

In some embodiments, the invention relates to any one of the aforementioned methods (e.g., a membrane stack or a spiral wound configuration), wherein the one or more interleaf layers are selected from the group consisting of screen, mesh, polypropylene, polyethylene, paper, and cellulose. In some embodiments, the interleaf is a screen or a non-woven material.

In some embodiments, the interleaf is mesh. In some embodiments, the interleaf is polypropylene or polyethylene. In some embodiments, the interleaf is non-woven polypropylene. In some embodiments, the interleaf is paper. In certain embodiments, the interleaf is cellulose.

In certain embodiments, the interleaf is mesh. In certain embodiments, the mesh interleaf is extruded netting. In certain embodiments, the mesh interleaf is about 0.45-mm mesh. In certain embodiments, the mesh interleaf is a biplanar thermoplastic netting. In certain embodiments, the mesh interleaf is substantially similar to Naltex (a particular biplanar thermoplastic netting), from DelStar Technologies, Inc.

In certain embodiments, the interleaf is spunbound polypropylene. In certain embodiments, the interleaf is spunbound polypropylene of basis weight of about 0.70 oz/yd² to about 0.95 oz/yd². In certain embodiments, the interleaf is spunbound polypropylene of basis weight of about 0.70 oz/yd², about 0.75 oz/yd², about 0.80 oz/yd², about 0.85 oz/yd², about 0.90 oz/yd², or about 0.95 oz/yd². In certain embodiments, the interleaf is spunbound polypropylene of basis weight about 0.86 oz/yd².

In certain embodiments, the interleaf is about 50 m to about 300 m thick. In certain embodiments, the interleaf is about 50 m, about 100 m, about 150 m, about 200 m, about 250 m, or about 300 m thick.

In certain embodiments, the interleaf has about 50% to about 99% volume porosity. In certain embodiments, the interleaf has about 70% to about 95% volume porosity. In certain embodiments, the interleaf has about 70%, about 75%, about 80%, about 85%, about 90%, or about 95% volume porosity. In certain embodiments, the interleaf has from about 80% to about 90% volume porosity. In certain embodiments, the interleaf is substantially compressible.

In some embodiments, one or more interleaf layers are in contact with one or more flow distribution layers.

Inner Core of Spiral Wound Configuration

In some embodiments the inner core is plastic. In some embodiments the inner core is polypropylene or polysulfone.

In some embodiments, the inner core is a cylinder. In certain embodiments, the inner core is a cylinder that is capped or sealed at both of its ends.

In certain embodiments, the inner core is a cylindrical pipe. In certain embodiments, the inner core is a perforated cylindrical pipe. In certain embodiments, the inner core is a perforated cylindrical pipe that is capped or sealed at one of its ends.

In some embodiments, the inner core is a screen wrapped around the cylinder. In certain embodiments, the screen provides a path by which fluid may flow.

In some embodiments, the invention relates to any one of the aforementioned methods, the composite material is a membrane.

In some embodiments, the invention relates to any one of the aforementioned methods, wherein the cross-linked gel is a neutral hydrogel, a charged hydrogel, a polyelectrolyte gel, a hydrophobic gel, a neutral gel, or a gel comprising functional groups.

In some embodiments, the invention relates to any one of the aforementioned methods, wherein the macroporous cross-linked gel comprises macropores having an average size of 10 nm to 3000 nm.

In some embodiments, the invention relates to any one of the aforementioned methods, wherein the pores of the support member have an average pore diameter of about 0.1 μm to about 50 μm.

In some embodiments, the invention relates to any one of the aforementioned methods, wherein a fluid flow path is substantially through the composite material.

In some embodiments, the invention relates to any one of the aforementioned methods, wherein a fluid flow path is substantially across the composite material.

### Methods of Making Exemplary Composite Materials

In certain embodiments, the invention relates to any one of the aforementioned methods, wherein the ratio of pendant reactive functional groups to grafting end groups in the monomeric mixture is from about 1:10 to about 2:1, for example, about 1:10, about 1:9, about 1:8, about 1:7, about 1:6, about 1:5, about 1:4, about 1:3, about 1:2, about 1:1, or about 2:1. In some embodiments, an alkyne group is equivalent to two alkene groups.

In certain embodiments, the invention relates to any one of the aforementioned methods, wherein the first monomer is present in the monomeric mixture in an amount from about 5% to about 25% by weight of the monomeric mixture. In certain embodiments, the invention relates to any one of the aforementioned methods, wherein the first monomer is present in the monomeric mixture in an amount from about 5% to about 20% by weight of the monomeric mixture.

In certain embodiments, the invention relates to any one of the aforementioned methods, wherein the second monomer is present in the monomeric mixture in an amount from about 0.1% to about 20% by weight of the monomeric mixture.

In certain embodiments, the invention relates to any one of the aforementioned methods, wherein the first cross-linker is present in the monomeric mixture in an amount from about 1% to about 20% by weight of the monomeric mixture.

In certain embodiments, the invention relates to any one of the aforementioned methods, wherein the photoinitiator is present in the monomeric mixture in an amount from about 0.1% to about 2% by weight of the monomeric mixture.

In certain embodiments, the invention relates to any one of the aforementioned methods, wherein the photoinitiator is benzoin or a benzoin ether, benzophenone, a dialkoxyacetophenone, 2,2-dimethoxy-2-phenylacetophenone, diphenyl(2,4,6-trimethylbenzoyl)phosphine oxide, a hydroxyalkylphenone, 1-hydroxy-cyclohexyl-phenyl-ketone, 4-(2-hydroxyethoxy)phenyl-(2-hydroxy-2-propyl)ketone, 1-[4-(2-hydroxyethoxy)-phenyl]-2-hydroxy-2-methyl-1-propane-1-one, 2-hydroxy-1-[4-(2-hydroxyethoxy)phenyl]-2-methyl-1-propanone, a α-hydroxymethyl benzoin sulfonic ester, 2-hydroxy-2-methylpropiophenone, lithium acylphospinate, or 2-methyl-1-[4-(methylthio)phenyl]-2-(4-morpholinyl)-1-propanone, 4,4′-azobis(4-cyanovaleric acid) (ACVA), or a mixture thereof.

In certain embodiments, the invention relates to any one of the aforementioned methods, wherein the first solvent comprises N,N′-dimethylacetamide (DMAc), (±)-1,3-butanediol (Budiol), di(propylene glycol)methyl ether acetate (DPMA), water, di(propylene glycol) dimethyl ether (DPM), di(propylene glycol) propyl ether (DPGPE), di(propylene glycol) methyl ether (DPGME), tri(propylene glycol) butyl ether (TPGBE), 3-methyl-1,3-butanediol, 3,3-dimethyl-1,2-butanediol, 3-methoxy-1-butanol, dimethyl sulfoxide (DMSO), ethylene glycol, di(ethylene glycol), tri(ethylene glycol), tetra(ethylene glycol), hexylene glycol, sodium dodecyl sulfate, or N,N-dimethylformamide (DMF), or a mixture thereof.

In certain embodiments, the invention relates to any one of the aforementioned methods, wherein N,N′-dimethylacetamide (DMAc) is present in the monomeric mixture in an amount from about 0% to about 70% by weight of the monomeric mixture. In certain embodiments, the invention relates to any one of the aforementioned methods, wherein N,N′-dimethylacetamide (DMAc) is present in the monomeric mixture in an amount from about 0% to about 50% by weight of the monomeric mixture. In certain embodiments, the invention relates to any one of the aforementioned methods, wherein N,N′-dimethylacetamide (DMAc) is present in the monomeric mixture in an amount from about 0% to about 70% by weight of the total solvents. In certain embodiments, the invention relates to any one of the aforementioned methods, wherein N,N′-dimethylacetamide (DMAc) is present in the monomeric mixture in an amount from about 0% to about 50% by weight of the total solvents.

In certain embodiments, the invention relates to any one of the aforementioned methods, wherein (±)-1,3-butanediol (Budiol) is present in the monomeric mixture in an amount from about 0% to about 50% by weight of the monomeric mixture. In certain embodiments, the invention relates to any one of the aforementioned methods, wherein (±)-1,3-butanediol (Budiol) is present in the monomeric mixture in an amount from about 0% to about 50% by weight of the total solvents.

In certain embodiments, the invention relates to any one of the aforementioned methods, wherein di(propylene glycol)methyl ether acetate (DPMA) is present in the monomeric mixture in an amount from about 0% to about 60% by weight of the monomeric mixture. In certain embodiments, the invention relates to any one of the aforementioned methods, wherein di(propylene glycol)methyl ether acetate (DPMA) is present in the monomeric mixture in an amount from about 0% to about 60% by weight of the total solvents.

In certain embodiments, the invention relates to any one of the aforementioned methods, wherein water is present in the monomeric mixture in an amount from about 0% to about 50% by weight of the monomeric mixture. In certain embodiments, the invention relates to any one of the aforementioned methods, wherein water is present in the monomeric mixture in an amount from about 0% to about 30% by weight of the monomeric mixture. In certain embodiments, the invention relates to any one of the aforementioned methods, wherein water is present in the monomeric mixture in an amount from about 0% to about 30% by weight of the total solvents.

In certain embodiments, the invention relates to any one of the aforementioned methods, wherein the covered support member is irradiated at about 350 nm.

In certain embodiments, the invention relates to any one of the aforementioned methods, wherein the period of time is about 1 minute, about 5 minutes, about 10 minutes, about 15 minutes, about 20 minutes, about 30 minutes, about 45 minutes, or about 1 hour.

In certain embodiments, the invention relates to any one of the aforementioned methods, wherein the composite material comprises macropores.

In certain embodiments, the invention relates to any one of the aforementioned methods, wherein the average pore diameter of the macropores is less than the average pore diameter of the pores.

### Pore Size Determination

SEM and ESEM

As mentioned above, in certain embodiments, the cross-linked gel is a macroporous cross-linked gel. The average diameter of the macropores in the macroporous cross-linked gel may be estimated by one of many methods. One method that may be employed is scanning electron microscopy (SEM). SEM is a well-established method for determining pore sizes and porosities in general, and for characterizing membranes in particular. Reference is made to the book Basic Principles of Membrane Technology by Marcel Mulder (© 1996) (“Mulder”), especially Chapter IV. Mulder provides an overview of methods for characterizing membranes. For porous membranes, the first method mentioned is electron microscopy. SEM is a very simple and useful technique for characterising microfiltration membranes. A clear and concise picture of the membrane can be obtained in terms of the top layer, cross-section and bottom layer. In addition, the porosity and pore size distribution can be estimated from the photographs.

Environmental SEM (ESEM) is a technique that allows for the non-destructive imaging of specimens that are wet, by allowing for a gaseous environment in the specimen chamber. The environmental secondary detector (ESD) requires a gas background to function and operates at from about 3 torr to about 20 torr. These pressure restraints limit the ability to vary humidity in the sample chamber. For example, at 10 torr, the relative humidity at a specific temperature is as follows:

| Relative Humidity at 10 torr (%) | T (° C.) |
|---|---|
| About 80 | About 16 |
| About 70 | About 18 |
| About 60 | About 20 |
| About 40 | About 24 |
| About 20 | About 40 |
| About 10 | About 50 |
| About 2 | About 70 |
| About 1 | About 100 |

This is a useful guide to relative humidity in the sample chamber at different temperatures. In certain embodiments, the relative humidity in the sample chamber during imaging is from about 1% to about 99%. In certain embodiments, the relative humidity in the sample chamber during imaging is about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 99%. In certain embodiments, the relative humidity in the sample chamber during imaging is about 45%.

In certain embodiments, the microscope has nanometer resolution and up to about 100,000× magnification.

In certain embodiments, the temperature in the sample chamber during imaging is from about 1° C. to about 95° C. In certain embodiments, the temperature in the sample chamber during imaging is about 2° C., about 3° C., about 4° C., about 5° C., about 6° C., about 7° C., about 8° C., about 9° C., about 10° C., about 12° C., about 14° C., about 16° C., about 18° C., about 20° C., about 25° C., about 30° C., about 35° C., about 40° C., about 45° C., about 50° C., about 55° C., about 60° C., about 65° C., about 70° C., about 75° C., about 80° C., or about 85° C. In certain embodiments, the temperature in the sample chamber during imaging is about 5° C.

In certain embodiments, the pressure in the sample chamber during imaging is from about 0.5 torr to about 20 torr. In certain embodiments, the pressure in the sample chamber during imaging is about 4 torr, about 6 torr, about 8 torr, about 10 torr, about 12 torr, about 14 torr, about 16 torr, about 18 torr, or about 20 torr. In certain embodiments, the pressure in the sample chamber during imaging is about 3 torr.

In certain embodiments, the working distance from the source of the electron beam to the sample is from about 6 mm to about 15 mm. In certain embodiments, the working distance from the source of the electron beam to the sample is about 6 mm, about 7 mm, about 8 mm, about 9 mm, about 10 mm, about 11 mm, about 12 mm, about 13 mm, about 14 mm, or about 15 mm. In certain embodiments, the working distance from the source of the electron beam to the sample is about 10 mm.

In certain embodiments, the voltage is from about 1 kV to about 30 kV. In certain embodiments, the voltage is about 2 kV, about 4 kV, about 6 kV, about 8 kV, about 10 kV, about 12 kV, about 14 kV, about 16 kV, about 18 kV, about 20 kV, about 22 kV, about 24 kV, about 26 kV, about 28 kV, or about 30 kV. In certain embodiments, the voltage is about 20 kV.

In certain embodiments, the average pore diameter may be measured by estimating the pore diameters in a representative sample of images from the top or bottom of a composite material. One of ordinary skill in the art will recognize and acknowledge various experimental variables associated with obtaining an ESEM image of a wetted membrane, and will be able to design an experiment accordingly.

Capillary Flow Porometry

Capillary flow porometry is an analytical technique used to measure the pore size(s) of porous materials. In this analytical technique, a wetting liquid is used to fill the pores of a test sample and the pressure of a non-reacting gas is used to displace the liquid from the pores. The gas pressure and flow rate through the sample is accurately measured and the pore diameters are determined using the following equation: The gas pressure required to remove liquid from the pores is related to the size of the pore by the following equation:

D=4×γ×cos θ/P

D=pore diameter
γ=liquid surface tension
θ=liquid contact angle
P=differential gas pressure
This equation shows that the pressure required to displace liquid from the wetted sample is inversely related to the pore size. Since this technique involves the flow of a liquid from the pores of the test sample under pressure, it is useful for the characterization of “through pores” (interconnected pores that allow fluid flow from one side of the sample to the other). Other pore types (closed and blind pores) are not detectable by this method.

Capillary flow porometry detects the presence of a pore when gas starts flowing through that pore. This occurs only when the gas pressure is high enough to displace the liquid from the most constricted part of the pore. Therefore, the pore diameter calculated using this method is the diameter of the pore at the most constricted part and each pore is detected as a single pore of this constricted diameter. The largest pore diameter (called the bubble point) is determined by the lowest gas pressure needed to initiate flow through a wet sample and a mean pore diameter is calculated from the mean flow pressure. In addition, both the constricted pore diameter range and pore size distribution may be determined using this technique.

This method may be performed on small membrane samples (e.g., about 2.5 cm diameter) that are immersed in a test fluid (e.g., water, buffer, alcohol). The range of gas pressure applied can be selected from about 0 to about 500 psi.

Other Methods of Determining Pore Diameter

Mulder describes other methods of characterizing the average pore size of a porous membrane, including atomic force microscopy (AFM) (page 164), permeability calculations (page 169), gas adsorption-desorption (page 173), thermoporometry (page 176), permporometry (page 179), and liquid displacement (page 181). Mulder, and the references cited therein, are hereby incorporated by reference.

### Exemplary Uses of the Composite Materials

In certain embodiments, the invention relates to a method, wherein a fluid is passed through the cross-linked gel of any one of the aforementioned composite materials. By tailoring the conditions for binding or fractionation, good selectivity can be obtained.

In certain embodiments, the invention relates to a method, further comprising the step of:
f. flowing at a fifth flow rate a first fluid comprising a substance substantially through or substantially across the composite material, thereby adsorbing or absorbing a portion of the substance onto the composite material.

In certain embodiments, the invention relates to a method, comprising the step of:
h. flowing at a seventh flow rate a first fluid comprising a substance substantially through or substantially across the composite material, thereby adsorbing or absorbing a portion of the substance onto the composite material.

In certain embodiments, the first fluid further comprises a fragmented antibody, aggregated antibodies, a host cell protein, a polynucleotide, an endotoxin, or a virus. In some embodiments, the first fluid is a suspension of cells or a suspension of aggregates.

In certain embodiments, the invention relates to any one of the aforementioned methods, wherein the fluid flow path of the first fluid is substantially through the macropores of the composite material.

In certain embodiments, the invention relates to any one of the aforementioned methods, wherein the fluid flow path of the first fluid is substantially perpendicular to the macropores of the composite material.

In certain embodiments, the invention relates to any one of the aforementioned methods, wherein substantially all of the substance is adsorbed or absorbed onto the composite material after the first fluid flows substantially through or substantially across the composite material.

In certain embodiments, the invention relates to any one of the aforementioned methods, further comprising the step of:
g. contacting at a sixth flow rate a second fluid with the substance adsorbed or absorbed onto the composite material, thereby releasing a portion of the substance from the composite material.

In certain embodiments, the invention relates to any one of the aforementioned methods, further comprising the step of:
i. contacting at an eighth flow rate a second fluid with the substance adsorbed or absorbed onto the composite material, thereby releasing a portion of the substance from the composite material.

In some embodiments, the invention relates to methods for coupling a ligand to a functionalized composite material, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member;
b. flowing at a first flow rate a first solution substantially through or substantially across the functionalized composite material, wherein the first solution comprises a plurality of first ligands, such that a plurality of covalent bonds forms between the reactive functional groups and the first ligands;
c. optionally, flowing at a second flow rate a first wash solution substantially through or substantially across the composite material to remove any excess first ligand;
d. flowing at a third flow rate a quenching solution substantially through or substantially across the composite material, wherein the quenching solution comprises a reactive compound to convert any residual pendant reactive functional groups to non-reactive groups;
e. optionally, flowing at a fourth flow rate a second wash solution substantially through or substantially across the composite material to remove any residual reactive compound;
f. flowing at a fifth flow rate a first fluid comprising a substance substantially through or substantially across the composite material, thereby adsorbing or absorbing a portion of the substance onto the composite material; and
g. contacting at a sixth flow rate a second fluid with the substance adsorbed or absorbed onto the composite material, thereby releasing a portion of the substance from the composite material;

wherein the functionalized composite material is arranged in a coplanar stack of coextensive sheets, a tubular configuration, or a spiral wound configuration.

In some embodiments, the invention relates to methods for coupling a ligand to a functionalized composite material, comprising the steps of:
a. providing a functionalized composite material comprising:
   i. a support member, comprising a plurality of pores extending through the support member; and
   ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member;
b. flowing at a first flow rate a first solution substantially through or substantially across the functionalized composite material, wherein the first solution comprises a plurality of first ligands, such that a plurality of covalent bonds forms between the reactive functional groups and the first ligands;
c. optionally, flowing at a second flow rate a first wash solution substantially through or substantially across the composite material to remove any excess first ligand;
d. flowing at a third flow rate a second solution substantially through or substantially across the functionalized composite material, wherein the second solution comprises a plurality of second ligands comprising at least three reactive groups, wherein the second ligand is a cross-linker, and, optionally, a polymerizable monomer comprising at least two pendant reactive functional groups, thereby forming a plurality of covalent bonds between the reactive functional groups and the second ligands;
e. optionally, flowing at a fourth flow rate a second wash solution substantially through or substantially across the composite material to remove any excess second ligand and, optionally, any excess polymerizable monomer;
f. flowing at a fifth flow rate a quenching solution substantially through or substantially across the composite material, wherein the quenching solution comprises a reactive compound to convert any residual pendant reactive functional groups to non-reactive groups; and
g. optionally, flowing at a sixth flow rate a third wash solution substantially through or substantially across the composite material to remove any residual reactive compound;
h. flowing at a seventh flow rate a first fluid comprising a substance substantially through or substantially across the composite material, thereby adsorbing or absorbing a portion of the substance onto the composite material; and
i. contacting at an eighth flow rate a second fluid with the substance adsorbed or absorbed onto the composite material, thereby releasing a portion of the substance from the composite material;

wherein the functionalized composite material is arranged in a coplanar stack of coextensive sheets, a tubular configuration, or a spiral wound configuration.

In certain embodiments, the invention relates to any one of the aforementioned methods, wherein the fluid flow path of the second fluid is substantially through the macropores of the composite material.

In certain embodiments, the invention relates to any one of the aforementioned methods, wherein the fluid flow path of the second fluid is substantially perpendicular to the macropores of the composite material.

In certain embodiments, the invention relates to any one of the aforementioned methods, wherein the substance is a biological molecule, biological ion, virus, or virus particle.

In certain embodiments, the invention relates to a method of separating a biological molecule or biological ion, such as proteins or immunoglobulins, from solution. In certain embodiments, the invention relates to a method of purifying a biological molecule or biological ion, such as proteins or immunoglobulins. In certain embodiments, the invention relates to a method of purifying proteins or monoclonal antibodies with high selectivity. In certain embodiments, the invention relates to a method, wherein the biological molecule or biological ion retains its tertiary or quaternary structure, which may be important in retaining biological activity.

In certain embodiments, the invention relates to any one of the aforementioned methods, wherein the substance is a biological molecule or biological ion selected from the group consisting of albumins, lysozyme, viruses, cells, T-globulins of human and animal origins, immunoglobulins of human and animal origins, hIgG, proteins of recombinant and natural origins, polypeptides of synthetic and natural origins, interleukin-2 and its receptor, enzymes, monoclonal antibodies, trypsin and its inhibitor, cytochrome C, myoglobin, myoglobulin, α-chymotrypsinogen, recombinant human interleukin, recombinant fusion protein, nucleic acid derived products, DNA of synthetic and natural origins, and RNA of synthetic and natural origins.

In some embodiments, the invention relates to any one of the aforementioned methods, wherein the substance is a biological molecule or biological ion selected from the group consisting of albumins, lysozyme, viruses, cells, T-globulins of human and animal origins, immunoglobulins of human and animal origins, hIgG, immunoglobulin M, proteins of recombinant and natural origins, (e.g., recombinant human growth hormone, recombinant human insulin, recombinant follicle-stimulating hormone, recombinant factor VII (anti-hemophilic factor), recombinant human erythropoietin, recombinant granulocyte colony-stimulating factor, recombinant alpha-galactosidase a, recombinant iduronidase, recombinant galsulfase, recombinant dornase alfa, recombinant tissue plasminogen activator, recombinant human interferons, recombinant insulin-like growth factor 1, and recombinant asparaginase), polypeptides of synthetic and natural origins, interleukin-2 and its receptor, enzymes, monoclonal antibodies, trypsin and its inhibitor, cytochrome C, myoglobin, myoglobulin, α-chymotrypsinogen, recombinant human interleukin, recombinant fusion protein, Factor VIII, Factor IX, antithrobin III, alpha-I-antitrypsin, nucleic acid derived products, DNA of synthetic and natural origins, and RNA of synthetic and natural origins.

In certain embodiments, the invention relates to any one of the aforementioned methods, wherein the biological molecule or biological ion is lysozyme, hIgG, myoglobin, human serum albumin, soy trypsin inhibitor, transferase, enolase, ovalbumin, ribonuclease, egg trypsin inhibitor, cytochrome c, Annexin V, or α-chymotrypsinogen.

In certain embodiments, the invention relates to any one of the aforementioned methods, wherein the substance is a biological molecule or the biological ion is selected from the group consisting of γ-globulins of human and animal origins, immunoglobulins of both human and animal origins, proteins of recombinant or natural origin including, polypeptides of synthetic or natural origin, monoclonal antibodies, antigens, bacterial immunoglobulin-binding proteins, recombinant fusion protein, Protein A, Protein G, Protein L, and Peptide H.

In certain embodiments, the invention relates to any one of the aforementioned methods, wherein the substance is a biological molecule or the biological ion is selected from the group consisting of a polypeptide, a protein, a recombinant protein, a bacterial immunoglobulin-binding protein, a recombinant fusion protein, Protein A, Protein G, Protein L, and Peptide H.

In certain embodiments, the invention relates to a method of recovering an antibody fragment from variants, impurities, or contaminants associated therewith. In certain embodiments, biological molecule or biological ion separation or purification may occur substantially in the cross-linked gel. In certain embodiments, biological molecule or biological ion separation or purification may occur substantially in the macropores of the cross-linked gel, when the cross-linked gel has macropores.

In certain embodiments, the invention relates to a method of reversible adsorption of a substance. In certain embodiments, an adsorbed substance may be released by changing the liquid that flows through the gel. In certain embodiments, the uptake and release of substances may be controlled by variations in the composition of the cross-linked gel.

In certain embodiments, the invention relates to any one of the aforementioned methods, wherein the first fluid is a clarified cell culture supernatant.

In certain embodiments, the invention relates to a method, wherein the substance may be applied to the composite material from a buffered solution. In certain embodiments, the invention relates to any one of the aforementioned methods, wherein the first fluid is a buffer.

In certain embodiments, the invention relates to any one of the aforementioned methods, wherein the concentration of the buffer in the first fluid is about 5 mM, about 10 mM, about 15 mM, about 20 mM, about 25 mM, about 30 mM, about 35 mM, about 40 mM, about 50 mM, about 60 mM, about 70 mM, about 75 mM, about 80 mM, about 85 mM, about 90 mM, about 95 mM, about 0.1 M, about 0.11 M, about 0.12 M, about 0.13 M, about 0.14 M, about 0.15 M, about 0.16 M, about 0.17 M, about 0.18 M, about 0.19 M or about 0.2 M.

In certain embodiments, the invention relates to any one of the aforementioned methods, wherein the pH of the first fluid is about 5, about 5.5, about 6, about 6.5, about 7, about 7.5, about 8, about 8.5, or about 9.

In certain embodiments, the invention relates to any one of the aforementioned methods, wherein the first fluid comprises sodium phosphate.

In certain embodiments, the invention relates to any one of the aforementioned methods, wherein the first fluid comprises a salt. In certain embodiments, the invention relates to any one of the aforementioned methods, wherein the concentration of the salt in the first fluid is about about 50 mM, about 60 mM, about 70 mM, about 75 mM, about 80 mM, about 85 mM, about 90 mM, about 95 mM, about 0.1 M, about 0.11 M, about 0.12 M, about 0.13 M, about 0.14 M, about 0.15 M, about 0.16 M, about 0.17 M, about 0.18 M, about 0.19 M about 0.2 M, about 0.25 M, or about 0.3 M. In certain embodiments, the invention relates to any one of the aforementioned methods, wherein the salt is sodium chloride.

In certain embodiments, the invention relates to any one of the aforementioned methods, wherein the substance is a binding partner. In certain embodiments, the invention relates to any one of the aforementioned methods, wherein the composite material comprises a coupled ligand, and the substance is the ligand's binding partner.

In certain embodiments, the invention relates to any one of the aforementioned methods, wherein the concentration of the substance in the first fluid is about 0.01 mg/mL to about 1,000 mg/mL. In certain embodiments, the invention relates to any one of the aforementioned methods, wherein the concentration of the substance in the first fluid is about 0.2 mg/mL to about 10 mg/mL. In certain embodiments, the invention relates to any one of the aforementioned methods, wherein the concentration of the substance in the first fluid is about 0.2 mg/mL, about 0.3 mg/mL, about 0.4 mg/mL, about 0.5 mg/mL, about 0.6 mg/mL, about 0.7 mg/mL, about 0.8 mg/mL, about 0.9 mg/L, about 1 mg/mL, about 1.2 mg/mL, about 1.4 mg/mL, about 1.6 mg/mL, about 1.8 mg/mL, about 2 mg/mL, about 3 mg/mL, about 4 mg/mL, about 5 mg/mL, about 6 mg/mL, about 7 mg/mL, about 8 mg/mL, about mg/mL, or about 10 mg/mL.

In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 1 membrane volumes (MV)/min to about 75 MV/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 3 membrane volumes (MV)/min to about 70 MV/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 5 MV/min to about 50 MV/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from the group consisting of about 5 MV/min, about 6 MV/min, about 7 MV/min, about 8 MV/min, about 9 MV/min, about 10 MV/min, about 11 MV/min, about 12 MV/min, about 13 MV/min, about 14 MV/min, about 15 MV/min, about 16 MV/min, about 17 MV/min, about 18 MV/min, about 19 MV/min, about 20 MV/min, about 20 MV/min, about 21 MV/min, about 22 MV/min, about 23 MV/min, about 24 MV/min, about 25 MV/min, about 26 MV/min, about 27 MV/min, about 28 MV/min, about 29 MV/min, about 30 MV/min, about 30 MV/min, about 31 MV/min, about 32 MV/min, about 33 MV/min, about 34 MV/min, about 35 MV/min, about 36 MV/min, about 37 MV/min, about 38 MV/min, about 39 MV/min, about 40 MV/min, about 40 MV/min, about 41 MV/min, about 42 MV/min, about 43 MV/min, about 44 MV/min, about 45 MV/min, about 46 MV/min, about 47 MV/min, about 48 MV/min, about 49 MV/min, and about 50 MV/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 10 MV/min to about 20 MV/min.

In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 50 L/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 25 L/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 10 L/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 1 L/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 0.5 L/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 100 mL/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 10 mL/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from about 0.5 mL/min to about 2 mL/min. In certain embodiments, the invention relates to any one of the aforementioned methods, wherein the first flow rate, the second flow rate, the third flow rate, the fourth flow rate, the fifth flow rate, the sixth flow rate, the seventh flow rate, and the eighth flow rate are each independently selected from the group consisting of about 0.5 mL/min, about 0.6 mL/min, about 0.7 mL/min, about 0.8 mL/min, about 0.9 mL/min, about 1 mL/min, about 1.1 mL/min, about 1.2 mL/min, about 1.3 mL/min, about 1.4 mL/min, about 1.5 mL/min, about 1.6 mL/min, about 1.7 mL/min, and about 1.8 mL/min.

In certain embodiments, the invention relates to a method, wherein the substance may be eluted using varying concentrations and pHs of aqueous salt solutions. In certain embodiments, the invention relates to any one of the aforementioned methods, wherein the second fluid is a buffer. In certain embodiments, the invention relates to any one of the aforementioned methods, wherein the second fluid comprises glycine-HCl or sodium citrate. In certain embodiments, the invention relates to any one of the aforementioned methods, wherein the second fluid comprises glycine-HCl or sodium citrate in a concentration of about 5 mM to about 2 M. In certain embodiments, the invention relates to any one of the aforementioned methods, wherein the second fluid comprises glycine-HCl or sodium citrate in about 5 mM, about 10 mM, about 20 mM, about 30 mM, about 40 mM, about 50 mM, about 60 mM, about 70 mM, about 80 mM, about 90 mM, about 100 mM, about 125 mM, about 150 mM, about 200 mM, about 300 mM, or about 400 mM.

In certain embodiments, the invention relates to any one of the aforementioned methods, wherein the pH of the second fluid is about 2 to about 8. In certain embodiments, the invention relates to any one of the aforementioned methods, wherein the pH of the second fluid is about 2, about 2.2, about 2.4, about 2.6, about 2.8, about 3, about 3.2, about 3.4, about 3.6, about 3.8, about 4, about 4.2, about 4.4, about 4.6, about 4.8, about 5, about 5.2, about 5.4, about 5.5, about 5.6, about 5.7, about 5.8, about 5.9, about 6, about 6.1, about 6.2, about 6.3, about 6.4, about 6.5, about 6.6, about 6.7, about 6.8, about 6.9, about 7.0, about 7.1, about 7.2, about 7.3, about 7.4, about 7.5, about 7.6, about 7.7, about 7.8, about 7.9, and about 8.0.

In certain embodiments, the invention relates to a method that exhibits high binding capacities. In some embodiments, the binding capacity of a composite material was higher when flow through conjugation methods were used compared to batch or dead-end conjugation methods were used. In certain embodiments, the invention relates to a method that exhibits binding capacities of about 1 mg/mL_{membrane}, about 2 mg/mL_{membrane}, about 3 mg/mL_{membrane}, about 4 mg/mL_{membrane}, about 5 mg/mL_{membrane}, about 6 mg/mL_{membrane}, about 7 mg/mL_{membrane}, about 8 mg/mL_{membrane}, about 9 mg/mL_{membrane}, about 10 mg/mL_{membrane}, about 12 mg/mL_{membrane}, about 14 mg/mL_{membrane}, about 16 mg/mL_{membrane}, about 18 mg/mL_{membrane}, about 20 mg/mL_{membrane}, about 30 mg/mL_{membrane}, about 40 mg/mL_{membrane}, about 50 mg/mL_{membrane}, about 60 mg/mL_{membrane}, about 70 mg/mL_{membrane}, about 80 mg/mL_{membrane}, about 90 mg/mL_{membrane}, about 100 mg/mL_{membrane}, about 110 mg/mL_{membrane}, about 120 mg/mL_{membrane}, about 130 mg/mL_{membrane}, about 140 mg/mL_{membrane}, about 150 mg/mL_{membrane}, about 160 mg/mL_{membrane}, about 170 mg/mL_{membrane}, about 180 mg/mL_{membrane}, about 190 mg/mL_{membrane}, about 200 mg/mL_{membrane}, about 210 mg/mL_{membrane}, about 220 mg/mL_{membrane}, about 230 mg/mL_{membrane}, about 240 mg/mL_{membrane}, about 250 mg/mL_{membrane}, about 260 mg/mL_{membrane}, about 270 mg/mL_{membrane}, about 280 mg/mL_{membrane}, about 290 mg/mL_{membrane}, about 300 mg/mL_{membrane}, about 320 mg/mL_{membrane}, about 340 mg/mL_{membrane} mg/mL_{membrane}, about 360 mg/mL_{membrane}, about 380 mg/mL_{membrane}, or about 400 mg/mL_{membrane} at 10% breakthrough.

### Exemplification

The following examples are provided as illustrations. It will be understood, however, that the specific details given in each example have been selected for purpose of illustration and are not to be construed as limiting the scope of the disclosure. Generally, the experiments were conducted under similar conditions unless noted.

### Example 1—General Materials and Methods

### Proteins

rProtein A-cys was obtained from Biomedal S.L (Seville, Spain). Polyclonal immuno γ-globulin IgG was obtained from Equitech-Bio Inc. (Kerrville, Tex., USA).

### Membrane Preparation

Protocol A

The crosslinker(s) and monomers (except thiol functionalized monomers, which were added 10 min prior to casting) were added with the photo-initiator (IRGACURE 2959) to a solvent mixture, and the mixture was stirred long enough to dissolve all components. A pre-weighed 7″×8″ porous support substrate sheet (non-woven polypropylene mesh) was placed on a polyethylene sheet, then ˜15 g of the polymer solution was poured into the substrate sheet. The impregnated substrate was subsequently covered with another polyethylene sheet. The sheet was pressed gently in a circular motion by hand in order to remove excess solution and any entrapped air bubbles. The polymerization process was initiated by irradiating with UV light (˜350 nm) the polymer solution/substrate sandwiched between polyethylene sheets in a closed chamber for 10 min. The resultant membrane was then removed from between the polyethylene sheets and subjected to extensive washing cycles that involved 20-30 minutes soaking periods in purified (RO) water (2-3 times) with agitation. The clean membranes were dried by hanging freely in the air at room temperature for ˜ 16 hours.

Protocol B

Membranes were made by polymerizing acrylate and or acrylamide monomers and crosslinkers within a support mesh material in a UV initiated reaction. Various functional membranes containing protein binding groups (e.g. ion exchange, hydrophobic interaction and hydrophilic interaction) may be produced in a single polymerization step by introducing suitable functional polymerizable groups into the gel polymerization solution. The wet washed membranes may also be subjected to an additional thermal treatment step to tune their performance and properties.

Epoxy-containing membranes, for example, may serve as a reactive media platform that may be converted to bio-affinity membranes by anchoring various ligands, such as Protein A, covalently onto the surface. Other ligands can also be conjugated to target other bio-molecules or entities such as viruses.

### Mass Gain, Wetting, and Permeability of Composite Membranes

The weight of the dried membrane was measured and used to calculate the mass gain. Wetting of the membrane was also determined by dispensing a 50 μL drop of distilled water on the membrane surface and measuring the time required for the drop to be absorbed within the membrane. To estimate membrane permeability, the flux of each membrane was determined using RO water (or acetate buffer pH 5) and a 7.7-cm diameter membrane sample, using 100 kPa applied pressure.

To estimate membrane permeability, the flux of RO water (or 132 mM acetate buffer pH 5) as mobile phase through each membrane was determined. Membranes were presoaked in testing fluid for at least 10 minutes prior to testing, flushed with ˜300 mL of testing liquid, then the amount of the testing liquid that passes under 100 kPa applied pressure through a circular membrane coupon of 7.7 cm diameter (with actual 7.3 cm available diameter) was determined. The flux is expressed in the amount of liquid per surface area per time (kg/m² h).

### Porous Structure Imaging

To probe the gel structure and porosity, environmental scanning electron microscopy (ESEM) was used to image the membrane in the wet state. A small coupon (˜7×5 mm) was wetted by soaking in distilled water for 10-15 minutes then examined using an ESEM instrument (FEI Quanta FEG 250 ESEM). The sample was placed on cooling stage to adjust the temperature to 5° C., and the image was examined at low pressure level (4.5-5.5 torr) and 50-55% relative humidity.

To probe the membrane structure in the dry state, Tescan Vega II LSU scanning electron microscope (SEM) (Tescan, Pa., USA) was used to image gold-coated membranes with voltage set to 10-20 kV.

### Pore Size Measurements

Membrane pore size (diameter) was measured using a CFP-1500-AE Capillary Flow Porometer (Porous Materials Inc., Ithaca, N.Y.), operated by CapWin software (V.6).

A small disc of membrane (2.5-cm diameter) was soaked in Galwick© wetting liquid (Porous Materials Inc., surface tension=15.9 dynes/cm) for 10 min, then it was gently squeezed between two pre-wetted filter paper discs (Whatman 5-70 mm) to remove excess solution, and the thickness of the wetted membrane was determined using a micrometer. The membrane disc was then placed on a 2.5-cm stainless steel mesh support disc. The support disc loaded with the test membrane was placed in the designated holder, with the membrane facing up. The metal cover was then gently placed on the holder and the test was run within the pressure range of 0-200 psi.

### Protein A Ligand Density on Composite Membranes

To measure the Protein A ligand density on the coupled membrane, the amount of the uncoupled protein, which remained after the coupling reaction, was determined and subtracted from the total ligand amount to give the amount of the coupled ligand, then it was divided by the membrane volume (mL) to express density in mg ligand per mL of membrane.

To determine the Protein A amount in solution, a series of protein solutions in 0.1 M phosphate buffer (pH 7.2) were made, the absorbance at 280 nm was measured for each, and a calibration curve was constructed from which the slope was determined.

For selected membrane formulas, coupons of 4 cm×7 cm were cut and their thicknesses were measured, from which the volume was calculated. The coupling reaction was carried out as outlined previously, and 20 mg were loaded to each membrane coupling reaction, individually. When the UV reaction was complete, the reaction solution was collected in a tube, then 3-5 mL of 0.1 M phosphate buffer were added to the reaction bag and used to wash the membrane by shaking for 20-25 min, then the resulting solution was added to the collection tube.

The washing cycle was repeated two additional times, then the final solution absorbance was measured and the amount of uncoupled protein was calculated using the calibration curve slope. The coupled ligand amount was determined by taking the difference between the total reacted and uncoupled amounts.

### Binding Capacity Measurement

Bio-Affinity IgG Binding Capacity

A 25-mm diameter membrane disc was placed in a 25-mm Natrix-Stainless Steel (SS) holder. 20 mL of binding buffer (20 mM sodium phosphate, 150 mM NaCl, pH 7.4) was passed through to equilibrate (˜160-200 bed volume/min). In the binding step, 0.5 mg/mL polyclonal IgG in binding buffer was passed through at flow rate of 1 mL/min until the UV absorbance of the effluent exceeded 10% of the feeding solution, and then 10-15 mL of buffer was passed through to remove unbound protein at flow rate 2 mL/min. In the elution step, the bound IgG was eluted by passing 10-14 mL of elution buffer (0.1 M glycine-HCl, or 0.1 M sodium citrate, both at pH 3) at flow rate 2 mL/min.

Cation Exchange IgG Binding Capacity

A 25-mm membrane disc was placed in a 25-mm Natrix-SS holder and 20 mL of binding buffer (132 mM sodium acetate, pH 5.0) were passed through to achieve equilibration. Then protein solution (0.5 mg/mL human polyclonal IgG (Equitech-Bio Inc.) in binding buffer) was passed through until the UV absorbance of the effluent exceeded 10% of the feeding solution, and then 10-15 mL of buffer was passed through the cell to wash unbound protein. In the elution step, the bound IgG was eluted by passing 10 mL of elution buffer (132 mM sodium acetate, 1 M NaCl, pH 5.0; or 50 mM Tris, 0.5 M NaCl, pH 8.5).

Hydrophobic Interaction Mode IgG Binding Capacity

A 25-mm membrane disc was placed in a 25-mm Natrix-SS holder and 20 mL of binding buffer (50 mM sodium phosphate, 1 M ammonium sulfate, pH 6.5) was passed through to achieve equilibration. Then, a protein solution (0.5 mg/mL human polyclonal IgG (Equitech-Bio Inc.) in binding buffer) was passed through until the UV absorbance of the effluent exceeded 10% of the feeding solution. Subsequently, 15-20 mL of buffer was passed through the cell to wash unbound protein. In elution step, the bound IgG was eluted by passing 10 mL of elution buffer (50 mM sodium phosphate, pH 7.0).

### Example 2—Exemplary Bulk Coupling Protocols

Conjugating Protein-A ligand to Click Alkene Membrane

To examine the feasibility of chemically binding biomolecules (with thiol functionality) to alkene membranes via a hydrothiolation click reaction, an engineered protein A ligand containing a cysteine residue was coupled to alkene membrane(s) (of different chemical formulas) and the bioactivity of the immobilized ligand was examined.

Protein A ligand lyophilized powder (r-Protein A-cys) was dissolved in PBS (20 mM sodium phosphate, 0.15 M NaCl, pH 7.4) to make a stock solution of 50 mg/mL. To make a coupling solution for each membrane, 0.4 mL of ligand stock solution was transferred into a small ziplock plastic bag (5×8 cm), to which 1.6 mL of 2 M phosphate buffer (pH 7.2) was added and then 50 μL of initiator (4,4′-azobis(4-cyanovaleric acid), ACVA) in DMAc (150 mg/mL) was added. The reaction solution was mixed well. The final reaction solution had a volume of ˜2.0 mL, and contained about 20 mg of ligand, and about 7.5 mg of initiator.

Alternatively, ACVA was dissolved in the reaction buffer (2 M phosphate, pH 7.2) at a concentration of 5 mg/mL in order to avoid using DMAc. For low salt experiment, the initiator was dissolved in 0.5 M phosphate at a concentration of 7.5 mg/mL.

To the bag loaded with coupling reactants, a 4×7-cm membrane coupon (pre-wetted in water) was added. The bag was shaken for a minute, then irradiated with UV light (˜365 nm) for 10 minutes. After irradiation was complete, the coupling solution was decanted, then 15-20 mL of washing buffer solution (0.1 M phosphate, pH 7.2) was added and the membrane was placed on the shaker for 10-15 minutes. The washing cycle was repeated three times, after which the membrane was either: (i) transferred into 8 mL of trehalose solution (10 wt. %), shaken for 10-15 minutes, and dried in an oven (50° C.) for 20-30 min; or (ii) stored in 0.1 M phosphate buffer.

For coupling in the presence of additives, ACVA was dissolved in 0.5 M potassium phosphate (pH 7.2) to make a solution having a concentration of 7.5 mg/mL. Protein A ligand was dissolved in 20 mM sodium phosphate buffer (pH 7.2) to make a 50 mg/mL stock solution. In each of three small bags (5×8 cm), 0.25 mL of ligand stock solution was mixed with 0.25 mL of initiator solution and 50 μL of an additive were added (cysteamine-HCl to reaction B bag, and 1-mercaptoethanol to reaction C bag).

After mixing the reaction solutions well, a 25-mm diameter membrane disc was placed in each bag and the reaction bags were shaken well, then irradiated by UV light for 10 minutes. The reaction solution was decanted, then membrane coupons were washed three times using 0.1 M sodium phosphate buffer (pH 7.2) and shaken for 10-15 minutes. The composite membrane coupons were stored in buffer (0.1 M sodium phosphate, pH 7.2) and tested for bio-affinity to IgG protein, as outlined above.

### Example 3—Flow Through Ligand Conjugation Effect

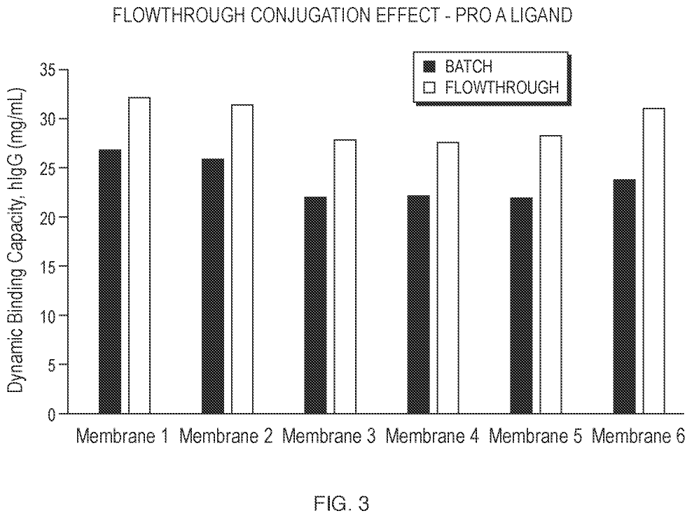

A sample disc of wetted membrane containing pendant reactive functional groups was placed into a stainless steel holder and attached to an AKTA chromatography system. Affinity ligand solution was pumped through the membrane holder at a defined flowrate for a prescribed length of time. Subsequently, a wash solution was pumped through the holder followed by a quenching solution containing a reactive compound that converts residual membrane pendant groups to non-reactive groups. Finally, a wash solution was pumped through the holder. The pump was stopped, the holder removed from the AKTA and the holder was disassembled to allow removal of the conjugated membrane. The human IgG dynamic binding capacity of the conjugated membranes (Protein A affinity ligand) was measured at a flowrate of 10 membrane volumes/minute and compared to membranes conjugated in a batch, non-flow through process (see FIG. 3). The membrane dynamic binding capacity was observed to be consistently higher when flow through conjugation was used.

### Example 4—Protein a Coupling by Flow Through a Stack of Membranes without Periodic Flow-Diverting Plates

To the bottom of a glass chromatography column with an internal diameter of 44 mm (VANTAGE® L Laboratory Column VL 44×250, catalogue number: 96440250) was attached a header containing a porous frit. Then a circular membrane with a diameter of 30 mm and a thickness of approximately 350 microns (volume 0.25 mL) was placed on the frit inside the column so that it was an equal distance from the column wall. The membrane had a surface containing epoxide groups. Then a circular section of polypropylene screen (1:2 twill weave, 500 micron mesh opening) with a diameter of 44 mm was placed in the column and lowered down so that it laid flat over the membrane and contacted the interior wall of the column. Then another 30 mm diameter membrane was placed in the column and lowered down so that it laid flat over the screen and was an equal distance from the wall of the column. The process of laying a screen above a membrane and then a membrane above of a screen was repeated until the column contained 100 membranes (total volume 25 mL) layered between 99 screens. Then a header was added to the top of the column and lowered until the membrane and screen layers were compressed to a height of 9.5 cm.

Next tubing was added to the inlet at the bottom of the column and tubing was also added to the outlet at the top of the column. The inlet tubing was connected through a peristaltic pump enabling the controlled flow of solutions through the column.

The air in the column and the tubing was displaced with a PBS buffer composed of 20 mM sodium phosphate with 150 mM sodium chloride at pH 7.4. The inlet tubing was placed into a glass bottle containing 400 mL of PBS buffer and the outlet tubing was directed to waste. Then the pump was started, and 200 mL of the PBS buffer was flowed through the column at a rate of 50 mL/min for 4 min. The pump was stopped, and the column was inverted. The connection of the inlet tubing and outlet tubing to column were then exchanged so that the inlet was again at the bottom of the column and the outlet was at the top of the column. The pump was started, and an additional 200 mL of the PBS buffer was flowed through the column at a rate of 50 mL/min for 4 min.

The pump was stopped, and the inlet tubing was moved into a glass bottle containing 500 mL of coupling buffer composed of 1.35 M potassium phosphate at pH 9.0. The outlet tubing remained directed to waste. The pump was started, and 200 mL of the coupling buffer was flowed through the column at a rate of 50 mL/min for 4 min. The pump was stopped, and the outlet tubing was placed in the same glass bottle as the inlet tubing which contained the remaining 300 mL of coupling buffer. In this configuration where the inlet tubing and the outlet tubing are in the same bottle the solution can be recirculated through the column many times. Recirculating a solution through the column allows extended reaction times without increasing the volume of the solution required.

To the glass bottle containing the remaining 300 mL of coupling buffer was added 82.4 mL of a PrA ligand stock solution with a concentration of 25.8 g/L in water. The pump was started and the PrA solution was then recirculated through column for 4 hours at a flow rate of 50 mL/min. The total PrA solution volume recirculating through the column was calculated to be 422.4 mL, which was composed of the 300 mL of coupling buffer remaining in the glass bottle, 40 mL of coupling buffer remaining in the column/tubing, and 82.4 mL of the PrA stock solution added. The PrA solution recirculated in the system was calculated to have a concentration of 5 g/L given that the 82.4 mL of stock PrA ligand solution containing 2.12 g of PrA ligand was diluted to a volume of 422.4 mL. The ligand loading on the membrane was calculated by dividing the total mass of PrA ligand of 2.12 g divided by the total membrane volume 25 mL to give a ligand loading of 85 g/L.

After 4 hours of the pump was stopped, and the outlet tubing was directed to waste, and the outlet tubing was directed to waste. The inlet tubing was placed into a glass bottle containing 200 mL of PBS buffer. The pump was started, and the PBS buffer was flowed through the column at a flow rate of 50 mL/min for 4 min.

The pump was then stopped, and the inlet tubing was placed into a glass bottle containing 800 mL of 1 M ethanolamine. The outlet tubing remained directed to waste. The pump was started, and 200 mL of the 1 M ethanolamine was flowed through the column to waste at a flow rate of 50 mL/min for 4 min. The pump was stopped and the outlet tubing was directed into the glass bottle containing the remaining 600 mL of the 1 M ethanolamine solution. The pump was then started, and the remaining 600 mL of the 1 M ethanolamine solution was recirculated through column for 3 hours at a flow rate of 50 mL/min.

The pump was stopped, and the outlet tubing was directed to waste. The inlet tubing was placed into a glass bottle containing 200 mL of a PBS buffer. The pump was started, and the PBS buffer was flowed through the column at a flow rate of 50 mL/min for 4 min.

The pump was stopped, and the top column header was removed. The membranes were removed and stored in PBS buffer. The flux and the IgG dynamic binding capacity of several membrane at different positions within the stack were determined. Position #1 is nearest to the column inlet, while position #100 was closest to column outlet. It was found that there was not a significant deviation in the membrane flux as the position was varied (Table 1). It was found that the membranes at positions 60 and 80 had a much lower IgG dynamic binding capacities suggesting that flow distribution in the column was not even.

TABLE 1
Membrane flux and IgG dynamic binding capacity
based on position of the membrane in the stack.

| Position of membrane | Flux | IgG dynamic binding capacity |
|---|---|---|
| within stack | (kg/m²/hr) | at a 10% breakthrough (g/L) |
| #1 | 3500 | 33.3 |
| #20 | 3840 | 31.5 |
| #40 | 4230 | 26.7 |
| #60 | 3980 | 5.6 |
| #80 | 4150 | 2.3 |
| #100 | 3790 | 33.4 |

### Example 5—Protein a Coupling by Flow Through a Stack of Membranes with Periodic Flow-Diverting Plates

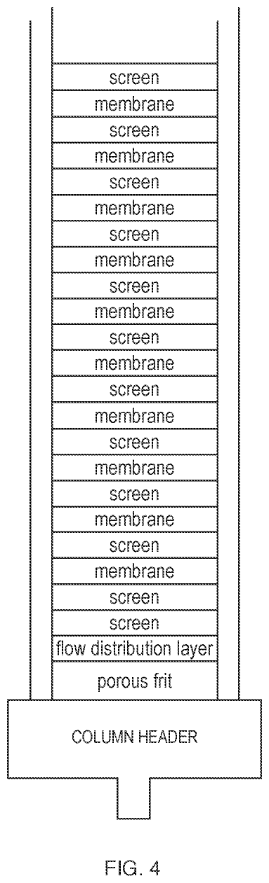

To the bottom of a glass chromatography column with an internal diameter of 44 mm (VANTAGE® L Laboratory Column VL 44×250, catalogue number: 96440250) was attached a header containing a porous frit. Then a flow distribution layer was composed of a circular impermeable plastic sheet approximately 0.025 inches in thickness with a diameter of 44 mm with a hole in the center having a diameter of 6 mm was lowered down so that it laid flat over the porous frit. Then two circular sections of a polypropylene screen (1:2 twill weave, 500 micron mesh opening) having a diameter of 44 mm were placed over the flow distribution layer. Then a circular membrane with 30 mm diameter and a thickness of approximately 350 microns (volume 0.25 mL) was placed on the screen so that it was an equal distance from the walls of the column. The membrane had a surface containing epoxide groups. Another a circular section of polypropylene screen was lowered down so that it laid flat over the membrane. The process of adding a membrane layer followed by a polypropylene screen layer was repeated 9 more times until the column had the follow composition shown in FIG. 4.

The process of assembling the layer in the column as described above was repeated nine more times until the column contained 100 membrane layers (total volume 25 mL), 120 screen layers, and 10 flow distribution layers. Then an additional flow distribution layer was added to the stack and a header with a porous frit was added to the top of the column. The header was lowered until the membrane, screen, and flow distributor layers were compressed to a height of 10.5 cm.

Next tubing was added to the inlet at the bottom of the column and tubing was also added to the outlet at the top of the column. The inlet tubing was connected through a peristaltic pump enabling the controlled flow of solutions through the column.

The air in the column and the tubing was displaced with a PBS buffer composed of 20 mM sodium phosphate with 150 mM sodium chloride at pH 7.4. The inlet tubing was placed into a glass bottle containing 400 mL of PBS buffer and the outlet tubing was directed to waste. Then the pump was started, and 200 mL of the PBS buffer was flowed through the column at a rate of 50 mL/min for 4 min. The pump was stopped, and the column was inverted. The connection of the inlet tubing and outlet tubing to column were then exchanged so that the inlet was again at the bottom of the column and the outlet was at the top of the column. The pump was started, and an additional 200 mL of the PBS buffer was flowed through the column at a rate of 50 mL/min for 4 min.

The pump was stopped, and the inlet tubing was moved into a glass bottle containing 500 mL of coupling buffer composed of 1.35 M potassium phosphate at pH 9.0. The outlet tubing remained directed to waste. The pump was started, and 200 mL of the coupling buffer was flowed through the column at a rate of 50 mL/min for 4 min. The pump was stopped, and the outlet tubing was placed in the same glass bottle as the inlet tubing which contained the remaining 300 mL of coupling buffer. In this configuration where the inlet tubing and the outlet tubing are in the same bottle the solution can be recirculated through the column many times. Recirculating a solution through the column allows extended reaction times without increasing the volume of the solution required.

To the glass bottle containing the remaining 300 mL of coupling buffer was added 82.4 mL of a PrA ligand stock solution with a concentration of 25.8 g/L in water. The pump was started and the PrA solution was then recirculated through column for 4 hours at a flow rate of 50 mL/min. The total PrA solution volume recirculating through the column was calculated to be 422.4 mL, which was composed of the 300 mL of coupling buffer remaining in the glass bottle, 40 mL of coupling buffer remaining in the column/tubing, and 82.4 mL of the PrA stock solution added. The PrA solution recirculated in the system was calculated to have a concentration of 5 g/L given that the 82.4 mL of stock PrA ligand solution containing 2.12 g of PrA ligand was diluted to a volume of 422.4 mL. The ligand loading on the membrane was calculated by dividing the total mass of PrA ligand of 2.12 g divided by the total membrane volume 25 mL to give a ligand loading of 85 g/L.

After 4 hours of the pump was stopped, and the outlet tubing was directed to waste. The inlet tubing was placed into a glass bottle containing 200 mL of PBS buffer. The pump was started, and the PBS buffer was flowed through the column at a flow rate of 50 mL/min for 4 min.

The pump was then stopped, and the inlet tubing was placed into a glass bottle containing 800 mL of 1 M ethanolamine. The outlet tubing remained directed to waste. The pump was started, and 200 mL of the 1 M ethanolamine was flowed through the column to waste at a flow rate of 50 mL/min for 4 min. The pump was stopped and the outlet tubing was directed into the glass bottle containing the remaining 600 mL of the 1 M ethanolamine solution. The pump was then started, and the remaining 600 mL of the 1 M ethanolamine solution was recirculated through column for 3 hours at a flow rate of 50 mL/min.

The pump was stopped, and the outlet tubing was directed to waste. The inlet tubing was placed into a glass bottle containing 200 mL of a PBS buffer. The pump was started, and the PBS buffer was flowed through the column at a flow rate of 50 mL/min for 4 min.

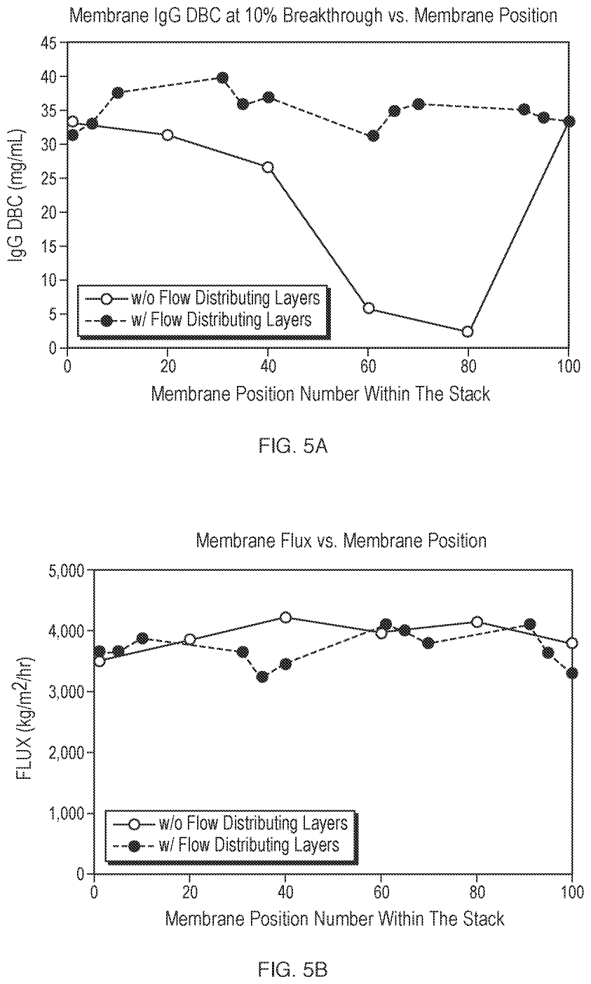

The pump was stopped, and the top column header was removed. The membranes were removed and stored in PBS buffer. The flux and the IgG dynamic binding capacity of several membranes at different positions within the stack were determined. Position #1 is nearest to the column inlet, while position #100 was closest to column outlet. It was found there was not a significant deviation in the membrane flux as the position was varied (Table 2). It was also found that there was not a significant deviation in the IgG dynamic binding capacities suggesting that flow distribution was relatively even throughout the column. The addition of the flow distributing layers provided even coupling of all the epoxide membranes in the stack with the PrA ligand (FIGS. 5A and 5B).

TABLE 2
Membrane flux and IgG dynamic binding capacity
based on position of the membrane in the stack.

| Position of membrane | Flux | IgG dynamic binding capacity |
|---|---|---|
| within stack | (kg/m²/hr) | at a 10% breakthrough (g/L) |
| 1 | 3630 | 31.4 |
| 5 | 3660 | 33.2 |
| 10 | 3880 | 37.7 |
| 31 | 3650 | 39.8 |
| 35 | 3240 | 35.9 |
| 40 | 3470 | 37.0 |
| 61 | 4090 | 31.2 |
| 65 | 3990 | 34.8 |
| 70 | 3790 | 36.0 |
| 91 | 4100 | 35.0 |
| 95 | 3630 | 33.9 |
| 100 | 3300 | 33.3 |

### Example 6—Protein a Coupling by Tangential Flow Through a Spiral Wound Roll of Membrane

A rectangular membrane with a width of 24.5 cm, a length of 62.5 cm and a thickness of 0.035 cm (total membrane volume of 53.6 mL) was wound with a plastic rectangular section of polypropylene screen (1:2 twill weave, 500 micron mesh opening) having a width of 25.4 cm around a cylindrical core having a diameter of 1.6 cm and a length of 25.4 cm. The membrane was centered so that there was 0.45 cm between the edge of the membrane and the edge of the screen. The membrane and screen were wrapped around the core with the screen contacting the core. The membrane and screen were rolled until the all of the membrane was completely covered by the screen layer. The screen layer was continued to be wound around the roll until the diameter of the roll was 32 mm. Then the screen layer was cut. Then the roll was slid into a glass chromatography column with an internal diameter of 32 mm (Vantage® L Laboratory Column VL 32×250, catalogue number: 96320250) so that the edge of the roll was 2.5 cm from both ends of the column. Then headers containing a porous frit were attached to the bottom and top of the column.

Next tubing was added to the inlet at the bottom of the column and tubing was also added to the outlet at the top of the column. The inlet tubing was connected through a peristaltic pump enabling the controlled flow of solutions through the column.

The air in the column and the tubing was displaced with a PBS buffer composed of 20 mM sodium phosphate with 150 mM sodium chloride at pH 7.4. The inlet tubing was placed into a glass bottle containing 400 mL of PBS buffer and the outlet tubing was directed to waste. Then the pump was started, and 200 mL of the PBS buffer was flowed through the column at a rate of 40 mL/min for 5 min. The pump was stopped, and the column was inverted. The connection of the inlet tubing and outlet tubing to column were then exchanged so that the inlet was again at the bottom of the column and the outlet was at the top of the column. The pump was started, and an additional 200 mL of the PBS buffer was flowed through the column at a rate of 40 mL/min for 5 min.

The pump was stopped, and the inlet tubing was moved into a glass bottle containing 1064 mL of coupling buffer composed of 1.35 M potassium phosphate at pH 9.0. The outlet tubing remained directed to waste. The pump was started, and 300 mL of the coupling buffer was flowed through the column at a rate of 40 mL/min for 7.5 min. The pump was stopped, and the outlet tubing was placed in the same glass bottle as the inlet tubing which contained the remaining 764 mL of coupling buffer. In this configuration where the inlet tubing and the outlet tubing are in the same bottle the solution can be recirculated through the column many times. Recirculating a solution through the column allows extended reaction times without increasing the volume of the solution required.

To the glass bottle containing the remaining 764 mL of coupling buffer was added 205.6 mL of a PrA ligand stock solution with a concentration of 25.8 g/L in water. The pump was started and the PrA solution was then recirculated through column for 4 hours at a flow rate of 40 mL/min. The total PrA solution volume recirculating through the column was calculated to be 1062.6 mL, which was composed of the 764 mL of coupling buffer remaining in the glass bottle, 93 mL of coupling buffer remaining in the column/tubing, and 205.6 mL of the PrA stock solution added. The PrA solution recirculated in the system was calculated to have a concentration of 5 g/L given that the 205.6 mL of stock PrA ligand solution containing 5.3 g of PrA ligand was diluted to a volume of 1064 mL. The ligand loading on the membrane was calculated by dividing the total mass of PrA ligand of 5.3 g divided by the total membrane volume 53.6 mL to give a ligand loading of 99 g/L.

After 4 hours of the pump was stopped, and the outlet tubing was directed to waste. The inlet tubing was placed into a glass bottle containing 200 mL of PBS buffer. The pump was started, and the PBS buffer was flowed through the column at a flow rate of 40 mL/min for 5 min.

The pump was then stopped, and the inlet tubing was placed into a glass bottle containing 600 mL of 1 M ethanolamine. The outlet tubing remained directed to waste. The pump was started, and 200 mL of the 1 M ethanolamine was flowed through the column to waste at a flow rate of 20 mL/min for 10 min. The pump was stopped and the outlet tubing was directed into the glass bottle containing the remaining 400 mL of the 1 M ethanolamine solution. The pump was then started, and the remaining 400 mL of the 1 M ethanolamine solution was recirculated through column for 170 minutes at a flow rate of 20 mL/min.

The pump was stopped, and the outlet tubing was directed to waste. The inlet tubing was placed into a glass bottle containing 400 mL of a PBS buffer. The pump was started, and the PBS buffer was flowed through the column at a flow rate of 40 mL/min for 10 min.

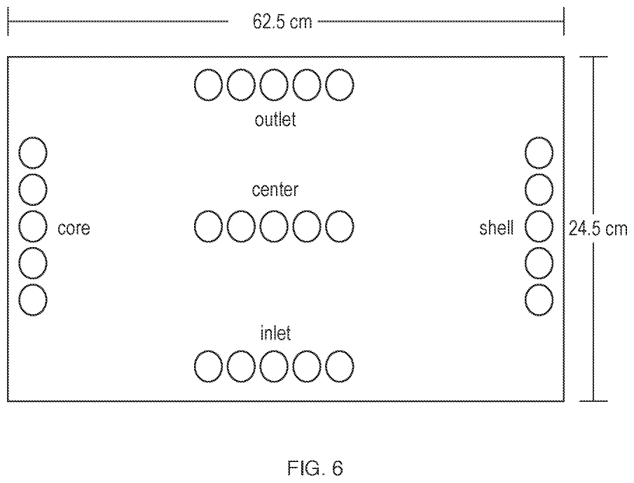

The pump was stopped, and the top and bottom column headers were removed. Then the wound roll of membrane and screen was removed from the column. The membrane was unwound and separated from the screen. Then circular sections of membrane with a 30 mm diameter were removed from the rectangular membrane sheet. Five circular sections of membrane were removed from each of the following locations (FIG. 6):

1. Center: located at the overall center of the rectangular membrane sheet.

2. Core: located at the middle of the edge of the rectangular membrane sheet that was closest to the core during the coupling reaction.

3. Shell: located at the middle of the edge of the rectangular membrane sheet that was closest to the column sides during the coupling reaction.

4. Inlet: located at the middle of the edge of the rectangular membrane sheet that was closest to the column inlet during the coupling reaction.

5. Outlet: located at the middle of the edge of the rectangular membrane sheet that was closest to the column inlet during the coupling reaction.

6. The five membranes removed from each section were assembled into five 5-layer membrane chromatography devices having a total accessible membrane volume of 1.0 mL. The pressure drop and the IgG dynamic binding capacity of the five chromatography devices were determined at a flow-rate of 10 membrane volumes per minute or 10 mL/min as shown in Table 3. It was found the that the 1 mL devices all had very similar pressure drops and IgG dynamic binding capacities at all five different locations. These results suggest that the tangential flow coupling of the epoxide membrane with a PrA ligand can be accomplished evenly across the membrane when it is interleafed with a polypropylene screen.

TABLE 3
Pressure drop and IgG dynamic binding capacity based on position
of the membrane in the spiral wound rectangular sheet.

| | Pressure drop | IgG dynamic binding capacity |
|---|---|---|
| | across device | at 10% breakthrough of 1 g/L |
| | at a flow rate | concentration of polyclonal |
| | of 10 membrane | IgG at a flow rate of |
| Location of where | volumes per | 10 membrane volumes per |
| samples were removed | minute (psi) | minute (g/L) |
| center | 18.1 | 28.9 |
| core | 19.3 | 27.9 |
| shell | 19.5 | 29.7 |
| inlet | 20.0 | 29.3 |
| outlet | 20.3 | 29.9 |

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

1. A method for coupling a ligand to a functionalized composite material, comprising the steps of:
a. providing a functionalized composite material, wherein the functionalized composite material is arranged in a coplanar stack of coextensive sheets, a tubular configuration, or a spiral wound configuration, comprising:
i. a support member, comprising a plurality of pores extending through the support member; and
ii. a macroporous cross-linked gel, wherein the macroporous cross-linked gel comprises a polymer formed from a reaction of one or more polymerizable monomers with one or more cross-linkers; the macroporous cross-linked gel comprises a plurality of pendant reactive functional groups; the macroporous cross-linked gel is located in the pores of the support member; and said macropores of the macroporous cross-linked gel are smaller than the pores of the support member; and
b. flowing at a first flow rate a first solution substantially through or substantially across the functionalized composite material, wherein the first solution comprises a plurality of first ligands, such that a plurality of covalent bonds forms between the reactive functional groups and the first ligands.

2. The method of claim 1, wherein the pendant reactive functional groups are selected from the group consisting of aldehydes, amines, carbon-carbon double bonds, carbon-carbon triple bonds, epoxides, hydroxyls, thiols, anhydrides, azides, reactive halogens, acid chlorides, and a mixture thereof.

3. The method of claim 1, wherein the pendant reactive functional groups are selected from the group consisting of carbon-carbon double bonds, carbon-carbon triple bonds, and thiols.

4. The method of claim 1, wherein the pendant reactive functional groups are derived from a molecule comprising a thiol functional group or a molecule comprising an unsaturated carbon-carbon bond.

5. The method of claim 4, wherein the pendant reactive functional groups are derived from a molecule comprising a thiol functional group; and the molecule comprising a thiol functional group is selected from the group consisting of 3-mercaptopropionic acid, 1-mercaptosuccinic acid, a polypeptide comprising a cysteine residue, a protein comprising a cysteine residue, a recombinant protein comprising a cysteine residue, a bacterial immunoglobulin-binding protein comprising a cysteine residue, a recombinant fusion protein comprising a cysteine residue, cysteamine, 1-thiohexitol, poly(ethylene glycol) 2-mercaptoethyl ether acetic acid, poly(ethylene glycol) methyl ether thiol, 1-thioglycerol, 2-naphthalenethiol, biphenyl-4-thiol, 3-amino-1,2,4-triazole-5-thiol, 5-(trifluoromethyl)pyridine-2-thiol, 1-[2-(dimethylamino)ethyl]-1H-tetrazole-5-thiol, 1-propanethiol, 1-butanethiol, 1-pentanethiol, 1-hexanethiol, 1-octanethiol, 8-amino-1-octanethiol hydrochloride, 3,3,4,4,5,5,6,6,7,7,8,8,8-tridecafluoro-1-octanethiol, 8-mercapto-1-octanol, and γ-Glu-Cys.

6. The method of claim 5, wherein the molecule comprising a thiol functional group is a polypeptide comprising a cysteine residue, a protein comprising a cysteine residue, a recombinant protein comprising a cysteine residue, a bacterial immunoglobulin-binding protein comprising a cysteine residue, and a recombinant fusion protein comprising a cysteine residue.

7. The method of claim 6, wherein the molecule comprising a thiol functional group is a protein comprising a cysteine residue.

8. The method of claim 4, wherein the pendant reactive functional groups are derived from a molecule comprising an unsaturated carbon-carbon bond; and the molecule comprising an unsaturated carbon-carbon bond is selected from the group consisting of 1-octene, 1-hexyne, 4-bromo-1-butene, allyldiphenylphosphine, allylamine, allyl alcohol, 3,4-dihydroxy-1-butene, 7-octene-1,2-diol, 3-allyloxy-1,2-propanediol, 3-butenoic acid, 3,4-dehydro-L-proline, vinyl laurate, 1-vinyl-2-pyrrolidinone, vinyl cinnamate, an acylamide, or an acrylate.

9. The method of claim 1, wherein the pendant reactive functional groups are selected from the group consisting of aldehydes, amines, epoxides, hydroxyls, anhydrides, azides, reactive halogens, and acid chlorides.

10. The method of claim 9, wherein the one or more monomers comprising a pendant reactive functional group are selected from the group consisting of glycidyl methacrylate, acrylamidoxime, acrylic anhydride, azelaic anhydride, maleic anhydride, hydrazide, acryloyl chloride, 2-bromoethyl methacrylate, and vinyl methyl ketone.

11. The method of claim 9, wherein the pendant reactive functional groups are amines.

12. The method of claim 9, wherein the pendant reactive functional groups are epoxides.

13. The method of claim 9, wherein the pendant reactive functional groups are hydroxyls.

14. The method of any one of the preceding claims, wherein the first ligand comprises a first functionality.

15. The method of claim 14, wherein the first ligand further comprises at least one grafting end-group; and the first functionality is selected from the group consisting of cationic, anionic, hydrophobic, hydrophilic, thiophilic, hydrogen bond donating, hydrogen bond accepting, pi-pi bond donating, pi-pi bond accepting, metal chelating, a biological molecule, and a biological ion.

16. The method of claim 15, wherein the first functionality is selected from the group consisting of cationic, anionic, hydrophobic, hydrophilic, thiophilic, hydrogen bond donating, hydrogen bond accepting, pi-pi bond donating, and pi-pi bond accepting.

17. The method of claim 15, wherein a molecule comprises a first functionality, and the molecule is selected from the group consisting of 2-(diethylamino)ethyl methacrylate, 2-aminoethyl methacrylate, 2-carboxyethyl acrylate, 2-(methylthio)ethyl methacrylate, acrylamide, N-acryloxysuccinimide, butyl acrylate or methacrylate, N,N-diethylacrylamide, N,N-dimethylacrylamide, 2-(N,N-dimethylamino)ethyl acrylate or methacrylate, N-[3-(N,N-dimethylamino)propyl]methacryl-amide, N,N-dimethylacrylamide, ethyl acrylate or methacrylate, 2-ethylhexyl methacrylate, hydroxypropyl methacrylate, glycidyl acrylate or methacrylate, ethylene glycol phenyl ether methacrylate, methacrylamide, methacrylic anhydride, propyl acrylate or methacrylate, N-isopropylacrylamide, styrene, 4-vinylpyridine, vinylsulfonic acid, N-vinyl-2-pyrrolidinone (VP), acrylamido-2-methyl-1-propanesulfonic acid, styrenesulfonic acid, alginic acid, (3-acrylamidopropyl)trimethylammonium halide, diallyldimethylammonium halide, 4-vinyl-N-methylpyridinium halide, vinylbenzyl-N-trimethylammonium halide, methacryloxyethyltrimethylammonium halide, 3-sulfopropyl methacrylate, 2-(2-methoxy)ethyl acrylate or methacrylate, hydroxyethyl acrylamide, N-(3-methoxypropyl acrylamide), N-[tris(hydroxymethyl)methyl]acrylamide, N-phenyl acrylamide, N-tert-butyl acrylamide, or diacetone acrylamide.

18. The method of claim 15, wherein the first functionality is a metal chelating functionality.

19. The method of claim 15, wherein the first functionality comprises a metal chelating functionality selected from the group consisting of octadentate, hexadentate, tetradentate, tridentate, bidentate, iminodicarboxylic acid, and iminodiacetic acid.

20. (canceled)

21. The method of claim 15, wherein the first functionality comprises a biological molecule or a biological ion functionality selected from the group consisting of albumins, lysozyme, viruses, cells, γ-globulins of human and animal origins, immunoglobulins of both human and animal origins, proteins of recombinant or natural origin including, polypeptides of synthetic or natural origin, interleukin-2 and its receptor, enzymes, monoclonal antibodies, antigens, lectins, bacterial immunoglobulin-binding proteins, trypsin and its inhibitor, cytochrome C, myoglobulin, recombinant human interleukin, recombinant fusion protein, Protein A, Protein G, Protein L, Peptide H, nucleic acid derived products, DNA of either synthetic or natural origin, and RNA of either synthetic or natural origin.

22.-79. (canceled)
